(19) United States
(12) Patent Application Publication
(10) Pub. No.: US 2025/0265778 A1
(43) Pub. Date: Aug. 21, 2025

(54) SYSTEM AND METHOD FOR GENERATING A BIRD-EYE VIEW MAP

(71) Applicant: Naver Corporation, Gyeonggi-do (KR)

(72) Inventors: Gianluca Monaci, Grenoble (FR); Leonid Antsfeld, Saint Ismier (FR); Boris Chidlovskii, Meylan (FR); Christian Wolf, Fontaines Saint Martin (FR)

(73) Assignee: Naver Corporation, Gyeonggi-do (KR)

(21) Appl. No.: 18/984,820

(22) Filed: Dec. 17, 2024

Related U.S. Application Data
(60) Provisional application No. 63/554,627, filed on Feb. 16, 2024.

(51) Int. Cl. G06T 17/05; G06T 7/536; G06T 15/04; G06T 15/06; G06T 17/20; G06V 10/77; G06V 10/82; G06V 20/17; G06V 20/64

(52) U.S. Cl. CPC G06T 17/05; G06T 7/536; G06T 15/04; G06T 15/06; G06T 17/20; G06V 10/7715; G06V 10/82; G06V 20/17; G06V 20/64; G06T 2200/08; G06T 2207/20081; G06T 2207/20084

(57) ABSTRACT

Methods and systems described herein generate a bird-eye view (BEV) map from a first-person view (FPV) image of a scene using trained machine-learning models. The methods include: generating a modal image, corresponding to the FPV image, that is representative of a feature of the FPV image; extracting, from the FPV image, a first set of feature maps (FM) with a first model, and from the modal image, a second set of FM with a second model; concatenating the first set of FM with the second set of FM to generate a set of tensors; generating a set of BEV FM with a third model that maps the set of tensors to the set of BEV FM; and decoding the set of BEV FM with a fourth model to generate the BEV map with the feature projected thereon.

### CROSS-REFERENCE TO RELATED APPLICATIONS

This application claims the priority to and the benefit of U.S. Provisional Application No. 63/554,627, filed on Feb. 16, 2024, which is hereby incorporated by reference in its entirety for all purposes.

### TECHNICAL FIELD

The present disclosure relates to terrestrial navigation using computer vision. More specifically, the present disclosure relates to the projection of first-person view (FPV) modalities from FPV images to a top-down bird's eye view (BEV) map.

### BACKGROUND

Localization plays a critical part in the performance of an autonomous navigation system. Typically, it depends on the accuracy of bird-eye view (BEV) maps pertaining to information of the surroundings of the robot. Different modalities are available from first-person view (FPV) image input through specialized pre-trained for segmentation of the FPV image and detection of areas/objects of interest from the image. However, projection of FPV modalities to a BEV map explicitly requires modeling the scene geometry and semantics, which is highly dependent on determination or prediction of accurate depth information of the surrounding.

Systems typically employ light detection and ranging (LIDAR) sensors to obtain depth information. However, LIDAR sensors add to the expense and computational complexity of the design. Moreover, LIDAR based systems are not highly reliable, as the sensing accuracy varies with changes in illumination and environmental conditions. Contemporary machine-vision based systems employ artificial intelligence (AI) based learning methods to estimate depth information. However, such systems are trained with end-to-end supervised learning, and thus require training a mapping function separately for each projected modality. This makes the modeling of such systems cumbersome and expensive, as it requires costly BEV annotations and a large custom dataset that is specific to each modality. Moreover, such systems require retraining if the modality is modified, e.g., if an object class is added, which is a major setback for such systems.

Thus, there remains a need for technical advancements in the available technology to address the shortcomings of contemporary autonomous navigation systems. Such advancements should ensure highly accurate and reliable projection of modalities from the FPV image to a corresponding BEV map, and thus effectively enhance the capabilities and operational accuracy for autonomous navigation.

### SUMMARY

In some embodiments, a computer-implemented method is provided, where a first-person view (FPV) image of a scene is received. A modal image corresponding to the FPV image is generated, where the modal image is representative of a feature of the FPV image. From the FPV image, a first set of feature maps is extracted with a first machine-learning model. From the modal image, a second set of feature maps is extracted with a second machine-learning model. One or more of the first set of feature maps are concatenated with corresponding one or more of the second set of feature maps to generate a set of tensors. A set of bird-eye view (BEV) feature maps are generated in a BEV plane with a third machine-learning model that maps the set of tensors to the set of BEV feature maps based on a correspondence between a set of polar coordinates associated with the BEV plane and a set of cartesian coordinates associated with the FPV image. The set of BEV feature maps are decoded with a fourth machine-learning model to generate a BEV map with the feature projected thereon for output to an output device.

The second machine-learning model may be trained with a data that is not representative of the feature of modal image. The data may be or may include a set of data triplets (I\hat{ }rgb,I\hat{ }zero, M\hat{ }zero), where each data triplet is generated by (i) generating a three-dimensional (3D) scene mesh structure; (ii) from an FPV position in a 3D scene mesh structure, recording an FPV image I\hat{ }rgb, (iii) applying a synthetic texture to the 3D scene mesh structure, (iv) from the FPV position in the 3D scene mesh structure with the applied synthetic texture, recording an FPV modal image I\hat{ }zero, (v) from a BEV position in the 3D scene mesh structure with the applied synthetic texture, recording a BEV feature map M\hat{ }zero, where the FPV modal image I\hat{ }zero and the BEV feature map M\hat{ }zero represent the same scene, and where the synthetic texture is decorrelated from the scene.

The receiving can receive the FPV image of the scene from a sensing unit and the decoding outputs to the output device that is one of a display and a printer.

The method may further include processing the BEV feature maps with a fifth machine-learning model for stacking the set of BEV feature maps before decoding the set of BEV feature maps with the fourth machine-learning model.

The first, second, third, fourth and fifth machine-learning models may be a first, second, third, fourth and fifth neural networks, respectively. The first, second, third and fourth machine-learning models may be a first, second, third and fourth neural networks, respectively. The second neural network may be trained using data with a synthetic image pattern superimposed on a 3D mesh of the scene. The synthetic image pattern need not be correlated with the scene. The second neural network may be trained using a training data of one or more modalities. The fourth neural network may decode one or more auxiliary outputs associated with the one or more modalities of the training data. The one or more auxiliary outputs may be decoded by the fourth neural network are one or more of navigability of the scene and obstacles in the scene. The third neural network may be a transformer-based network configured to compute one or more attention metrics.

The method may further include, for each tensor of the set of tensors: generating a contextualized feature column by a column encoder configured to compute a self-attention for each column of the tensor of the set of tensors; and transforming the contextualized feature column to a BEV ray map by deploying a ray decoder configured to compute a sequence of one or more self-attentions and one or more cross-attentions for each ray map of the BEV feature map of the set of BEV feature maps.

The method ay further include generating a residual BEV feature map for the FPV image and the modal image; where the fourth machine-learning model process the residual BEV feature map and the BEV feature maps. Generating the residual BEV feature map may further include: determining a monocular depth value of the FPV image using a monocular depth estimation technique; generating a perspective projection of the FPV image using inverse perspective projection of the modal image and the monocular depth value of the FPV image; pooling the perspective projection to generate a single-channel tensor of the FPV image; and passing the single-channel tensor through the one or more embedding layers to generate the residual BEV feature map.

The feature of the modal image may be a modality of the FPV image that includes semantic segmentation, motion vector, optical flow, occupancy, mask, object instance, scene navigation, scene obstacles or object bounding box.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a block diagram of a system to project modalities of a first-person view (FPV) image to a bird-eye view (BEV) map, in accordance with an embodiment of the present disclosure.

FIG. 2A depicts one or more components of the system of FIG. 1 in accordance with an embodiment of the present disclosure.

FIG. 2B depicts one or more components of the system of FIG. 2A in accordance with an embodiment of the present disclosure.

FIG. 2C depicts one or more components of the system of FIG. 1 in accordance with an embodiment of the present disclosure.

FIG. 3A illustrates an example block diagram including one or more components of a subsystem from the FIG. 2A.

FIG. 3B illustrates an example block diagram including one or more components from the FIG. 3A.

FIG. 4 illustrates an example of a data generation process by procedurally projecting generated random textures onto a 3D scene structure.

FIG. 5 illustrates a casual model of a data generation process in accordance with an embodiment of the present disclosure.

FIG. 6 illustrates training input pairs for three different zero-shot data generation variants in accordance with an example implementation.

FIG. 7 illustrates qualitative results on a Habitat-Matterport semantics dataset (HM3DSem), in accordance with an example implementation of the present disclosure.

FIG. 8 illustrates visualizations of attention distribution, in accordance with an example implementation of the present disclosure.

FIG. 9 illustrates zero-shot projections of objects in accordance with an example implementation of the present disclosure.

FIG. 10 illustrates optical flow calculated on an FPV pair, in accordance with an example implementation of the present disclosure.

FIG. 11A illustrates qualitative results on the HM3DSem dataset for a first set of test scenes, in accordance with an example implementation of the present disclosure.

FIG. 11B illustrates qualitative results on the HM3DSem dataset for a second set of test scenes, in accordance with an example implementation of the present disclosure.

FIG. 11C illustrates qualitative results on the HM3DSem dataset for a third set of test scenes, in accordance with an example implementation of the present disclosure.

FIG. 12 illustrates an example of a computer system that can implement at least one example of the disclosed method.

FIG. 13 shows an example flowchart of a computer-implemented method to project a modality of the FPV image to BEV map in accordance with some embodiments of the present disclosure.

### DETAILED DESCRIPTION

The subject matter of exemplary embodiments, as disclosed herein, is described with specificity to meet statutory requirements. However, the description itself is not intended to limit the scope of this patent. Rather, the inventor/inventors have contemplated that the claimed subject matter might also be embodied in other ways, to include different features or combinations of features similar to the ones described in this document, in conjunction with other technologies. Generally, the various embodiments including the exemplary embodiments relate to systems and methods for projecting the modalities of a first-person view (FPV) image to a bird-eye view (BEV) top-down map.

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration”. Any embodiment or design described herein as “exemplary” is not necessarily to be construed as preferred or advantageous over other embodiments or designs.

In various embodiments disclosed hereinafter, systems, components, and/or methods (i.e., one or more processes) for projecting a modality of a first-person view (FPV) image to a bird-eye view (BEV) top-down map are presented.

For several reasons, BEV maps are generally preferred to FPV maps in the field of robotics. Such reasons include, generating comprehensive spatial awareness, simplifying path planning and navigation, and facilitating obstacle avoidance. BEV maps may also be easier to integrate with existing mapping and geographic information systems (GIS) data, which are typically presented in a bird's-eye view (BEV). For human operators controlling or monitoring robots and driving vehicles, BEV maps are often more intuitive and easier to understand compared to FPV, making it simpler to issue commands and interpret the actions and environment of robots.

Additionally, BEV map can play a significant role in robotics due to its unique geometric structure, offering several key advantages that may include elimination of perspective distortion, aligning more closely with the Euclidean space where a robot may function. BEV maps can efficiently encapsulate a variety of modalities offering versatility for a range of applications, including navigation and strategic planning. The techniques disclosed herein provide a method for converting various FPV modalities, such as semantic segmentation, object detection, and optical flow, into a BEV top-down map, with no depth information. Traditionally, these FPV modalities are processed through specific pre-trained segmenters and detectors. However, the transition of this data to a BEV map typically requires explicit modeling of the geometry of the scene and access to dense depth information, which is often unreliable or unavailable in real-world scenarios. Current alternative vision-based learning methods, trained via end-to-end supervised learning, may require individual mapping functions for each modality, making the process laborious and dependent on expensive BEV annotations. The techniques disclosed herein provide a technical solution to the technical problem of generating BEV maps from FPV image data (e.g., an FPV image) without being trained on data representing a feature of modal image data associated with the FPV image data (e.g., an FPV modal image). In embodiments, during training, the FPV image and the FPV modal image (e.g., binary image) are semantically decorrelated and correlated only by the geometric scene structure. This may be achieved in simulation thereby avoiding complications and high cost of implementation in the field or in a live environment.

BEV top-down maps are used in various applications of autonomous navigation such as trajectory identification of autonomous aerial vehicles, driver-less vehicles, automated inventory delivery and management systems, etc. As previously mentioned, the available systems used for the generation of BEV maps commonly utilize either LIDAR sensors or artificial intelligence (AI) based learning models. LIDAR systems are expensive and unreliable, whereas AI-based systems may require training a mapping function separately for each projected modality, which makes modeling in such systems cumbersome and expensive due to the requirement of large custom datasets for each modality. The accuracy of the BEV maps may depend on the estimation of the relation between the scene geometry and semantics which are entangled. Thus, the system may demand at least accurate in-depth information and/or specific training for different modalities. The systems and methods disclosed herein disentangle the geometric inverse perspective projection from the modality transformation, and thus may provide a zero-shot solution for efficient projection of FPV modalities to a BEV plane to generate a BEV map, without utilizing modality specific training.

Advantageously some embodiment disclosed herein may be used to generate BEV maps from FPV maps when direct depth information is lacking. In an instance, the mapping is purely geometrical and does not modify the nature of the content, thus keeping the modality and only changing the viewpoint. The methods described within are general and may be used to project a particular modality, including semantic segmentation, motion vectors and object bounding boxes, to BEV maps without requiring a priori training in that particular modality.

Initially, an FPV image may be captured and pre-processed to estimate a modal image associated with any modality (e.g., semantic segmentation, object detection, optical flow etc.) of the FPV image. The pair of input images may be fed into a feature extractor that may include a first machine-learning (ML) model to extract features from the input FPV image and a second ML model to extract features from the modal image. The features from each layer of the first ML model may be concatenated with the corresponding layer of the second ML model. This concatenation may result in a set of tensors that are fed into a third machine-learning model based on transformer architecture. The transformer module may include a column encoder and a ray decoder to generate an initial BEV feature map based on a correspondence between a set of polar coordinates associated with a BEV plane and cartesian coordinates associated with the FPV image. For each layer of the feature extractor or for each tensor, a neural network with a transformer architecture may be used to calculate this correspondence by calculating self-attention and cross attention metrics for the set of tensors. After the BEV feature map is generated in polar coordinates, it is converted to cartesian BEV coordinates using an affine transformation.

In some embodiments, the neural network may employ a residual branch with monocular depth estimation (MDE) to generate a residual BEV feature map. Such a variant of the present technique is termed in the forgoing discussion as “zero-BEV residual” variant. The residual branch may take the input FPV image to estimate depth based on monocular depth estimation (MDE). This estimated depth along with the modal image may be used to generate inverse perspective projection that may be further processed by a pooling layer. The output from the perspective projection may be fed into one or more trainable embedding layers to generate the residual BEV feature map. The initial BEV feature map may be updated by combining the residual BEV feature map and the initial BEV feature map by one or more embedding layers. This residual variant may combine the power of MDE models and the advantages of an end-to-end trained model, which can infer unobserved and occluded information. This combination may outperform the capabilities of methods based on inverse projection.

The generated BEV feature maps from the transformer module may be fed to a post-processing subsystem that may be configured to model regularities across the BEV map. The post-processing system may include one or more ML models that may take BEV feature maps as input and generate a BEV map as output.

In another aspect, the disclosed model is optionally augmented with an auxiliary supervision of an additional modality (e.g., a binary occupancy map for navigation and obstacle) that is available during training. Such an additional modality can be computed from privileged information in simulation. The post-processing subsystem may further determine the auxiliary output corresponding to the FPV image to update the parameters of the ML models. This auxiliary output may lead to a refined training of the post processing subsystem for generation of the BEV maps.

In one embodiment, a zero-shot modality is determined based on the FPV image, that is further used to generate the BEV map. The post-processing subsystem may utilize the zero-shot modality using one or more machine-learning (ML) and/or data optimization techniques to generate (or predict) the BEV map.

The term “zero-shot”, as used herein, refers to a scenario where the ML model is capable of making predictions or performing tasks without a labeled dataset of input-output pairs. After training, any unseen modality can be projected from an FPV image to a BEV map using a modal image that is representative of a feature of the FPV image, where the ML model is trained with data that is not representative of the feature of the modal image.

In another aspect, an inductive bias is introduced for the disentanglement between geometry and modality. For this setting, the base model is modified. In the RGB stream, the FPV image may be fed to the feature extractor generating FPV feature maps and a subsequent first transformer module to project the FPV features into the BEV plane, as in the base model. For the other modality, the zero-shot image may be fed to the feature extractor that generates FPV feature maps and fed into a second transformer module to project the FPV features into the BEV plane. This second transformer module is constructed such that it uses the same cross-attention of the first transformer module and has value projections fixed to “Identity”. This may be done to encourage the zero modality to not modify the value of the input zero-shot image and use the same FPV to BEV transformation of the RGB modality. The BEV feature maps from the RGB and zero-shot modality in the BEV plane are concatenated along the channel dimension and fed to a post-processing block similar to the base model.

The various aspects including the example aspects are now described more fully with reference to the accompanying drawings, in which the various aspects of the disclosure are shown. The disclosure may, however, be embodied in different forms and should not be construed as limited to the aspects set forth herein. Rather, these aspects are provided so that this disclosure is thorough and complete, and fully conveys the scope of the disclosure to those skilled in the art. In the drawings, the sizes of components may be exaggerated for clarity.

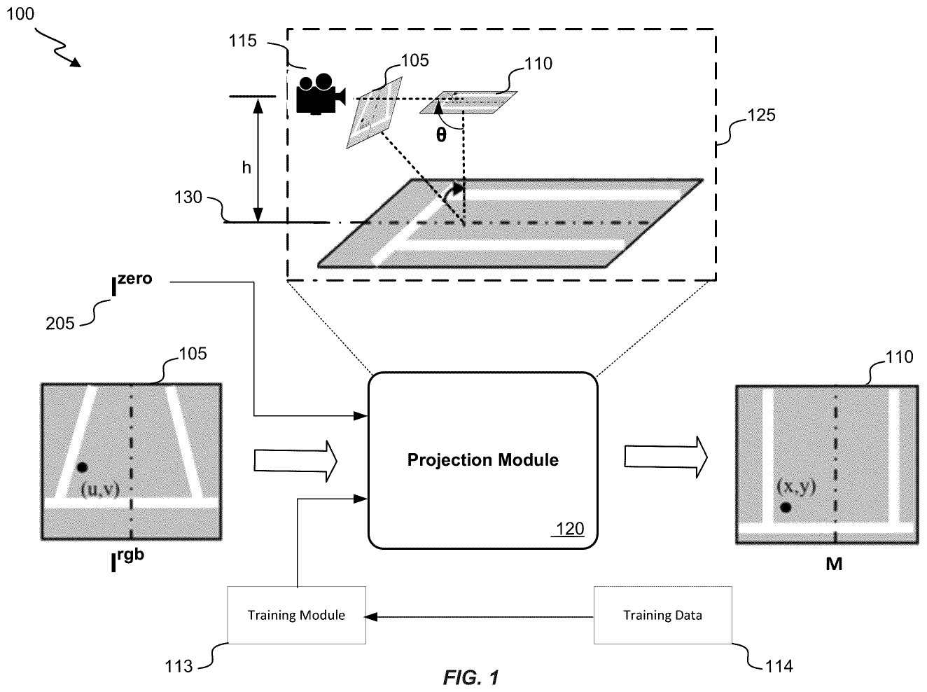

Referring now to the drawings, FIG. 1 depicts a block diagram of a system 100 configured to use a modal image 205 (e.g., a binary mask of a class or detected objects) to project a modality of an FPV image 105 to a BEV map 110, according to an exemplary embodiment, where the system 100 is not trained on the modality of the modal image 205. The system 100 includes a sensing unit 115 and a subsystem 120 (i.e., projection module) for projecting FPV image 105 using modal image 205 to BEV map 110. Further, during training, the system 100 includes a training module 113 and training data 114. The components of the system 100 may be communicatively coupled to each other by way of one or more wired and/or wireless communication means.

The sensing unit 115 is configured to capture a digital image of an environment (or a scene of interest) in first-person view (FPV) 105 that can be processed further to generate the BEV map 110. In some aspects of the present disclosure, the sensing unit 115 may include one or more camera units. Each camera unit may have an image capturing lens, a camera processing unit, and a camera storage unit. The image capturing lens of each camera may be capable of capturing an image of the environment based on a configuration space (i.e., intrinsic, and extrinsic parameters) of the camera. In an embodiment, the image capturing system may capture a colored image of the environment compatible with a three-color model (such as RGB model). The camera processing unit may generate initiation signals to trigger the image processing lens to capture the image. The FPV image from the sensing unit 115 may be considered a monocular image that represents a 2D visual representation captured by a single-lens camera. The term monocular often refers to an image, taken from a single lens, lacking direct depth information.

Moreover, the camera processing unit may determine a three-dimensional pixel value for each pixel of the colored image based on the three-color model. The camera processing unit may assign red-green-blue (RGB) intensity values to each pixel based on the determined three-dimensional pixel value and may represent the RGB intensity values using eight bits such that each intensity value of the RGB intensity values can take a value from 0 to 255. Furthermore, the camera processing unit may generate the digital image of the environment in FPV image 105 that is represented by the RGB intensity values corresponding to each pixel of the captured image. The camera storage may store instructions and/or data associated with the operation of the associated camera unit. Examples of the camera units of the sensing unit 115 may include but are not limited to a stationary camera, a pan-tilt-zoom (PTZ) camera, a camera-pair, etc. Aspects of the present disclosure are intended to include or otherwise cover any type of camera unit, without deviating from the scope of the present disclosure. According to some embodiments, the sensing unit 115 may be operatively attached to a user device (not shown here) as an integral component of the user device (such as a camera of the user device). The user device may be capable of transmitting, processing, storing, receiving, and/or displaying FPV image 105 or BEV image 110 to a user.

An example of how the subsystem 120 may project the FPV image 105 captured from a sensing unit 115 to a BEV map 110 is illustrated in block 125. The process includes taking a monocular visual observation in FPV image 105, I^{rgb} ∈ R^{W×H×3} of size W×H, and learning a mapping ϕ to translate it into BEV map 110 of varying modality, M=ϕ(I), where M∈R^{W′×H′×K}, W′×H′ is the size of BEV map 110 (M), and K is the dimension of the modality for a single cell of the map.

In some aspect of the present disclosure, intrinsic parameters of the sensing unit 115 to capture the FPV image 105 are used to determine the correspondence between the set of polar coordinates and the cartesian coordinates. In the illustrative block 125, sensing unit 115 may capture the FPV image (I^{rgb}) 105 from a height h with reference to the ground level 130. The focus is to project the FPV image 105 to BEV map 110 at an angle θ while projecting a modality thereon (i.e., a feature associated with the FPV modal image 205).

The mapping problem M=ϕ(I), may comprise of two parts: (i) understanding scene semantics, e.g. detecting occupancy from color input, and (ii) solving the geometric problem, which may require assigning pixel locations e.g., (u, v) in the FPV image 105 to cell positions (x, y) in the BEV map 110. The latter may correspond to an inverse perspective projection, which can be solved in a purely geometric way when cameras are calibrated, and depth is available. However, since the FPV image 105 relies on a monocular setup, it lacks depth information. This is because in many situations, depth sensors may not be applicable or not reliable. In other instances, generalizing the underlying correspondence to forms beyond inverse perspective projections may permit complex visual reasoning processes. For instance, an example of generalizing may be to exploit spatial regularities in scenes to predict content occluded or unseen in the FPV image 105, e.g., navigable spaces behind objects. Beyond the inference of unseen scene elements, spatial regularities may also play a role in solving the simpler and more basic inverse perspective projection problem itself, which is difficult in the absence of depth information.

In an example embodiment during inference, the sensing unit 115 may include a subsystem that determines one or more modalities from the FPV image 105 by generating one or more modal images I^{zero} 205 corresponding to the FPV image 105. In an embodiment, the modalities may include at least one of, semantic segmentation, motion vectors, and object bounding boxes. However, the scope of the present disclosure is not limited to this set. In other aspects of the present disclosure, examples of modalities may further include occupancy, latent representations, optical flow, texture determination, scene geometry estimation, etc.

In an aspect of the present disclosure, the modal image I^{zero} 205 from any modality available in FPV beyond RGB may be considered (e.g., semantic segmentation, optical flow) by the projection module 120 and mapped to the corresponding BEV map 110 M^{zero} without the projection module 120 having been trained on the modality. In an example embodiment, this mapping is purely geometric not modifying the nature of the content that is keeping the modality but changing the viewpoint. The FPV modal input I^{zero} might not include sufficient information for this projection, i.e., in cases where bounding boxes are projected from FPV image 105 to BEV map 110. In one example, the objective is to learn a mapping, φ^{zero}, to translate an FPV image I^{rgb} 105 and respective modal image, I^{zero}, into a BEV image, M^{zero}. Here, M^{zero}=ϕ^{zero} (I^{rgb}, I^{zero}), where ϕ^{zero} is the targeted mapping.

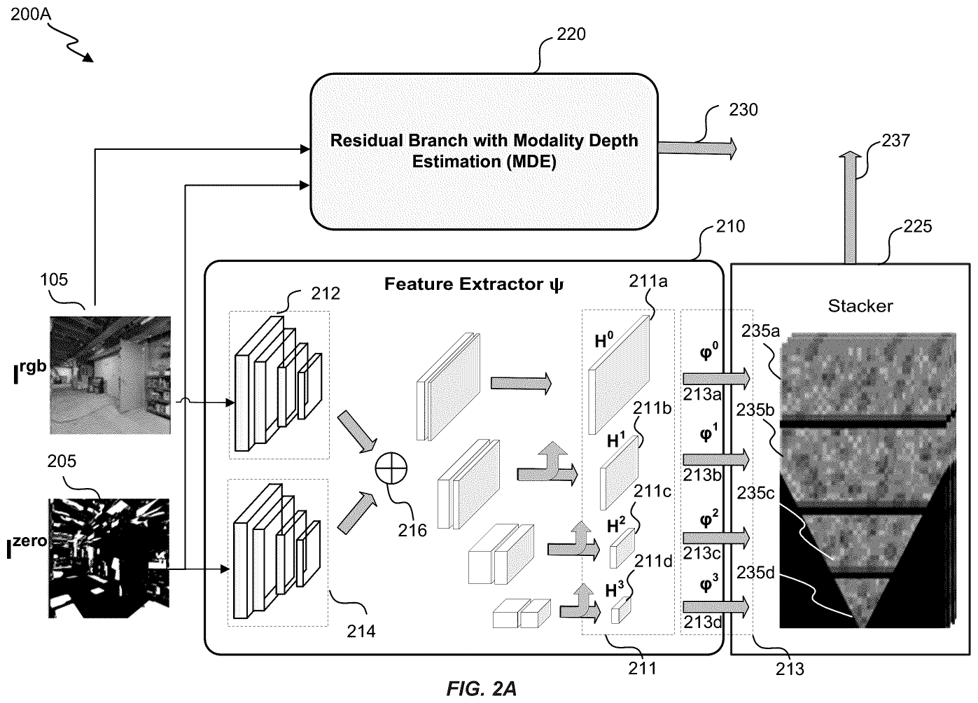

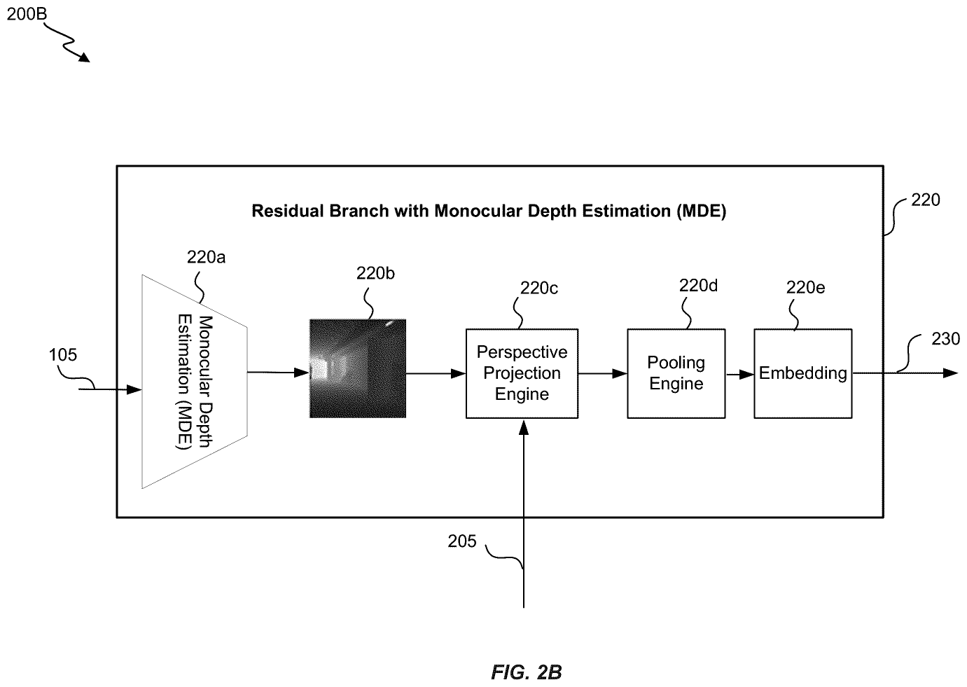

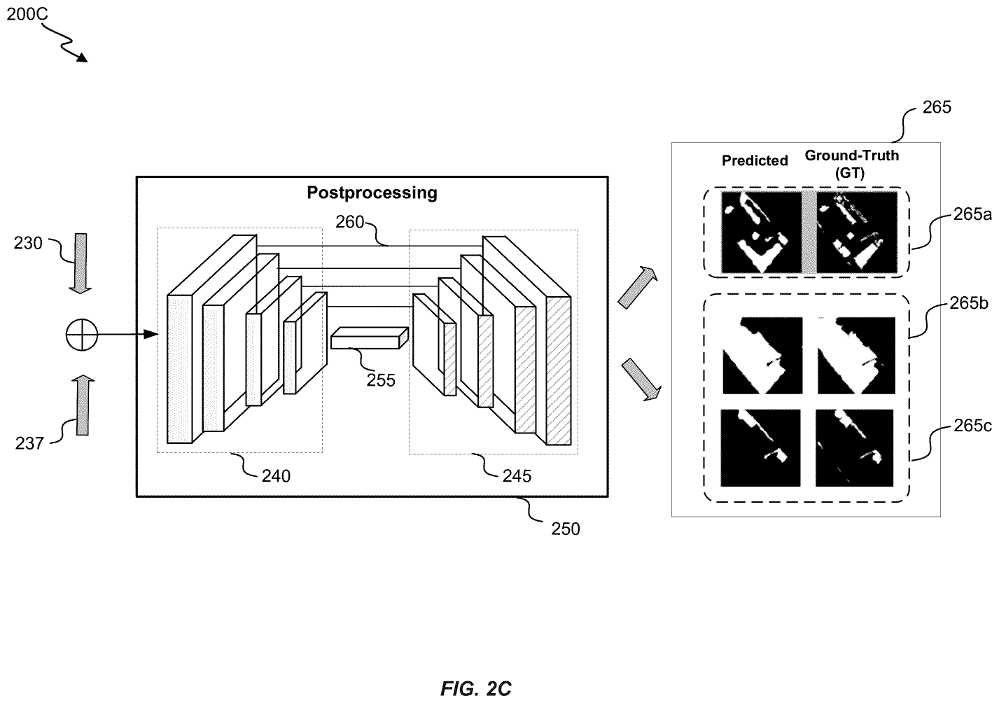

The term “zero-shot” as used herein refers to the ability of the projection module 120 to process a targeted modality of FPV image, I^{rgb}, 105 during inference when a labeled dataset of pairs (I^{zero}, M^{zero}) of the targeted modality were not available during training. More generally, zero-shot refers herein to the ability of a machine-learning (ML) model to make predictions for an unseen modality that was not encountered during training (i.e., zero-shot refers to the unseen modal images that are not present during training). Advantageously after training, any modal image 205 with modality unseen at training time may be projected with the FPV image 105 to produce a BEV map 110 with the modality unseen at training time projected thereon. One approach to this mapping uses depth estimation, inverse projection, and pooling to the ground (a residual branch explained later). However, this method may not infer BEV structures invisible in FPV image. An FPV image I^{rgb} 105 and a corresponding modal image zero 205 are two inputs to the projection module 120 that undergo two different networks (as shown in FIG. 2A) to extract features that are used in further projection of FPV images 105 to process selected modalities of modal images, I^{zero}, 205 to BEV maps 110.

FIG. 2A depicts system components 200A of the projection module 120 of FIG. 1 in accordance with an embodiment of the present disclosure. A pre-processing feature extractor 210 of the system components 200A, which forms part of a base architecture, receives an input FPV monocular image I^{rgb} 105 (e.g., from sensing unit 115), a modal image I^{zero} 205 (e.g., generated at inference by sensing unit 115 from the input FPV image I^{rgb} 105 of any modality). As discussed below, system components 200A that are optional include a residual branch with modality depth estimation (MDE) 220 and a stacker 225. The modal image I^{zero} 205 may belong to one or more modalities that may include at least one of, semantic segmentation, motion vectors, and object bounding boxes, however the scope of the present disclosure is not limited to such modalities. In some other aspects of the present disclosure, examples of one or more modalities may further include occupancy, latent representations, optical flow, texture determination, scene geometry estimation and the like.

The aim of the backbone feature extractor network y 210 is to extract features from the input images 205) in the form of a tensor H=ψ(I). The full mapping ϕ can be obtained by training a model as: M=(I)=ϕ′(ψ(I))=ϕ′(H).

In an example implementation, the model training process involves supervision with ground-truth BEV maps, which serve as reference outputs for the model to learn from. In such supervised training setting as discussed below, the FPV modal image I^{zero} 205 and the corresponding output BEV map M^{zero} may be generated from the synthetic image patterns superimposed on a three-dimensional (3D) mesh of the scene to achieve the zero-shot objective.

In an example embodiment, model training is done with such supervised training to understand/untangle the information related to scene geometry and the information related to the modality used in projecting FPV image 105 to a BEV map 110. During such training, this disentanglement may be achieved through a dedicated loss combined with synthetically generated data with targeted statistical properties. The synthetically generated data may include FPV image I^{rgb} 105 combined with a synthetically generated pseudo-random zero-shot data stream I^{zero} (i.e., input pairs) with the output M^{zero} leading to data triplets (I^{rgb}, I^{zero}, M^{zero}). The term “pseudo-random”, as used herein, suggests that the generation of the output image M^{zero} follows a deterministic process that is random in nature. In ML, this term often involves using a random seed to generate diverse yet reproducible examples. The output BEV maps may be synthetically labeled with geometric transforms using the ground-truth 3D scene structure. The targeted statistical properties of the generated data for training may include the geometric alignment of input pairs i.e., I^{rgb} 105 and I^{zero} 205, meaning they are taken from the same viewpoint. The other property may involve that the content of the zero-shot modality (I^{zero} 205) is decorrelated from the content of the primary modality (I^{rgb} 105) up to the 3D scene structure. This means that the textures on the 3D scene structure are procedurally generated and may not depend on scene properties.

For training a mapping function ϕ, the projection module 120 may utilize the synthetically generated data triplets (I^{rgb}, I^{zero}, M^{zero}). This mapping function ϕ may take concatenated input image pairs and output the predicted BEV map (\hat{M}^{zero}). The network may be trained using any segmentation loss function such as focal loss, cross-entropy loss, or dice loss. In an example implementation, the network is trained using Dice loss, a common loss function used in image segmentation tasks. During testing in zero-shot settings, the trained model may map the input pairs to the output BEV map (\hat{M}^{zero}) using the learned mapping function q.

Referring again to FIG. 2A, the feature extractor 210 may include a pair of neural networks dedicated for each input image i.e., 212 (for FPV image I^{rgb} 105) and 214 (for modal input I^{zero} 205). The modal input I^{zero} 205 is a binary image of a modality of the FPV image I^{rgb} 105. In an embodiment, the first neural network 212 may generate a first feature vector corresponding to the first set of features such that each feature of the first feature vector is orthogonal to the others.

In some aspects of the present disclosure, the first neural network 212 may employ a first trained model to extract the first set of features. In an embodiment, the first trained model may be a pre-trained ResNet-50 convolution neural network (CNN) that includes several convolutional layers such that each convolution layer of the ResNet-50 CNN is responsible for extracting features of the first set of features. Aspects of the present disclosure are intended to include or otherwise cover any type of features in the first set of features that can be extracted using the ResNet-50 CNN, without deviating from the scope of the present disclosure. In other aspects, the first neural network 212 may be a custom-trained neural network comprising of multiple layers for extracting features or other pre-trained networks such as VGG (Visual Geometry Group). The purpose of these networks is to extract features while maintaining the spatial structure and FPV of the input image.

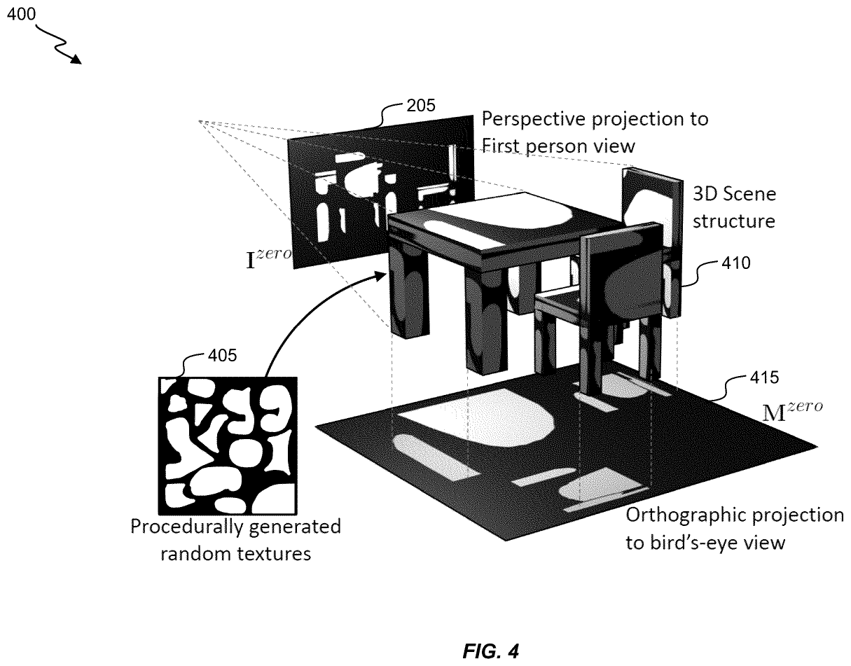

The second neural network 214 may extract the second set of features from the modal image I^{zero} 205. In an embodiment, the second neural network 214 may generate a second feature vector corresponding to the second set of features such that each feature of the second feature vector is orthogonal to the others. In some aspects of the present disclosure, the second neural network 214 may employ a second trained model. In an embodiment, the second trained model may be a pre-trained multi-layered CNN. In at least one example, the number of layers of the multi-layered CNN is four, the kernel size of the multi-layered CNN is three, a stride value of two, and a padding value of one. Aspects of the present disclosure are intended to include or otherwise cover other values of these hyper parameters (e.g., number of layers, stride, size of kernel), without deviating from the scope of the present disclosure. In one embodiment, the second neural network 214 is trained using data, as discussed above, generated with a synthetic image pattern added on top of (i.e., superimposed on) a 3D scene structure (e.g., mesh) as discussed with reference to FIG. 4, where the synthetic image pattern is a random pattern decorrelated with the scene.

The concatenation module 216 may receive the first feature map from the first neural network 212 and the second feature map from the second neural network 214 and generate a first tensor H⁰ 211a. The concatenation module 216 may be coupled with the first neural network 212 by way of a first channel. Moreover, the concatenation module 216 may be coupled with the second neural network 214 by way of a second channel. In an embodiment, dimensions of the first and second channels may be equal such that the dimensions of the first and second channels can be referred to as “the channel dimension”. The channel dimension is the depth of the network or modality. The concatenation module 216 may further determine the channel dimension and concatenate the feature map from all the layer of first neural network 212 and the feature map from the respective layers of second neural network 214 along the channel dimension to generate the concatenated tensors e.g., 211a, 211b, 211c, 211d. These tensors may comprise feature maps of decreasing spatial dimensions (e.g., of order 2, 4 or 8) of the input image. In other words, for concatenation, it may be required for the two feature maps from both the neural networks (i.e., a first neural network 212 and a second neural network 214) to match the spatial resolution with each other in the resultant tensor H^{b}, where b represents the number of layers from which the tensor is extracted. The tensor H^{b}∈R^{S×R}^{_{b}}^{×C}^{_{b}}, where S is the spatial dimension of a tensor, which may be same for all the tensors, R_{b} is the dimension of the tensor at layer b, and C_{b} is the channel at layer b of a tensor H. Although the number of layers extracted may vary, in an example implementation, the outputs of four intermediate layers are taken comprising four tensors i.e., H⁰ 211a, H¹ 211b, H² 211c, H³ 211d that produce feature maps of spatial dimensions as ¼, ⅛, 1/16, 1/32 of the input image, respectively.

In another aspect, the features maps at different resolutions and channel depths from both the networks (212 and 214) are concatenated at 216 for each layer (e.g., two modalities concatenated along the channel dimension) and may be fed to an optional feature pyramid to form intermediate representations or tensors H^{b} (e.g., H⁰ 211a, H¹ 211b, H² 211c, H³ 211d). The feature pyramid may up-sample the low-resolution feature-maps and combine them with those at higher resolution to provide context for the higher resolution features—this typically improves performance. In an example implementation, the feature pyramid includes four tensor maps H^{b} that have same input spatial dimensions. Aspects of the present disclosure are intended to include or otherwise cover any number of feature maps of the feature pyramid, without deviating from the scope of the present disclosure such that each feature map may have any resolution and channel depths.

A neural network ϕ 213 converts tensors 211 to initial BEV feature maps 235. Learning the mapping ϕ 213 from FPV images 105 to BEV maps 110 may require assigning a position in polar coordinates (θ, ρ) in the BEV image 110 for each cartesian position (x, y) in the first-person tensor H. To achieve this, one approach may be to use the intrinsics of a calibrated camera of the sensing unit 115 to solve the correspondence between image column c and polar ray θ. The depth may not be used to solve the correspondence problem but by solving it as a learning problem. The FPV to BEV correspondence calculations may be performed by the FPV image 105 to BEV map 110 transformer-based mapping system 213. The network 213 performs mapping and may comprise of a sequence of cross-attention layers producing an initial BEV feature map termed M^{feat} 235.

The transform-based mapping system (ϕ) 213 (also referred to as transformer module in foregoing embodiment) may receive the tensors H^{b} (e.g., 211a, 211b) from the concatenation module 216 directly or from an optional feature pyramid and generate a set of initial BEV feature maps 235 in BEV plane. In an exemplary embodiment, the neural mapping system 213 is a neural network based on the transformer architecture, which is one way to implement an attention-based (e.g., self-attention, cross-attention) mechanism. Transformer architecture as used herein is described in Ashish Vaswani et al., “Attention is all you need”, In I. Guyon et al., editors, Advances in Neural Information Processing Systems 30, pages 5998-6008, Curran Associates, Inc., 2017, which is incorporated herein by reference. Additional information regarding the transformer architecture can be found in U.S. Pat. No. 10,452,978, which is incorporated herein by reference. Alternate attention-based architectures include recurrent, graph and memory-augmented neural networks.

FIG. 2B depicts one or more components of the system of FIG. 2A in accordance with an embodiment of the present disclosure. Apart from feature extractor 210 with transformer subsystem 213, the system 120 may employ optionally a residual branch 220 with monocular depth estimation (MDE) to generate a geometry-based prediction of the BEV map [symbol] 230, also termed as the “predicted residual BEV feature map”. Such a variant of the present technique is termed in the forgoing discussion as “zero-BEV residual” variant. Referring to FIG. 2B, residual branch may add a zero-shot component 205 based on monocular depth estimation (MDE) 220a followed by perspective projection engine 220c that may perform inverse perspective projection P⁻¹ of the zero-shot modality and a pooling engine 220d that performs pooling to the ground. The process can be formulated as, [symbol] =max_{y}[P⁻¹(MDE(I^{rgb}),I^{zero})], where max_{y} indicates max pooling over the vertical dimension. In an example implementation, the predicted residual BEV map [symbol] 230 is passed through an embedding layer 220e and the resulting tensor is added to the transformer output and fed to a postprocessing sub system 250 that comprises a neural network. This residual variant may combine the power of MDE models and the advantages of an end-to-end trained model, which can infer unobserved and occluded information. This combination may outperform the capabilities of methods based on inverse projection.

The MDE module 220a may use a metric monocular depth estimation (MDE) method to generate a geometry-based prediction of the BEV map, [symbol] from I^{rgb} 105. The MDE can be done by Omnidata MDE model, which estimates normalized dense depth from RGB images. A pretrained Omnidata MDE model can be deployed and finetuned on a dataset of interest e.g., RGB-metric depth image pairs to generate absolute (i.e. unnormalized) depth. The estimated depth image 220b may be fed into the perspective projection engine 220c that may compute a 3D point-cloud of the scene (3D representation of the scene based on depth information) and back-project the image I^{zero} 205 into the 3D camera frame. This can be achieved by associating each pixel in I^{zero} 205 with the corresponding pixel in the estimated depth image 220b and hence the 3D point-cloud.

The values in the point-cloud may be quantized (by counting) into a voxel representation. Furthermore, the output from the residual block, residual BEV map [symbol] 230 can be obtained by feeding the 3D point-cloud from the perspective projection engine 220c. The pooling engine 220d may generate a residual binary BEV map by performing max pooling on the voxel representation to the ground, e.g., summing the voxel content over the height dimension and thresholding values larger than 0. This resulting BEV map is projected by trainable embedding layers 220e into the residual BEV map [symbol] 230.

FIG. 2C depicts one or more components of the system of FIG. 1 in accordance with an embodiment of the present disclosure. The system may comprise of a postprocessing component 250 that may process the initial BEV feature maps M^{feat} 235 from the transformer module 213 by combining it with an optional residual output [symbol] 230 by trainable embedding layers. The postprocessing 250 may include an encoder 240 that may take the input and convert it into a latent representation 255. The post-processing subsystem 250 may further comprise of a decoder network 245 that may take the latent representation and generate the final output BEV maps 265a (left). It may be understood that the processing is being done for the individual rays of the BEV plane. It may cause the decoder to model regularities across rays that the ray-wise transformer may not capture. In an example implementation, the post-processing subsystem 250 a convolutional backbone and a structure similar to a U-Net. The initial BEV feature map M^{feat} 235 may be processed by the first three meta-layers of a ResNet18 network, leading to three feature maps at different resolutions that are up-sampled back to the original spatial resolution, with skip connections 260 between encoder-decoder features of corresponding sizes.

In one aspect, the base architecture of the disclosed technique (i.e., without residual branch 220), as illustrated in FIGS. 2A and 2C, may include channel-concatenated input images [I^{rgb}, I^{zero}] fed to the feature extractor w 210, a subsequent transformer module 213 followed by a stacker 225 and a post-processing subsystem 250. The stacker 225 takes as input an initial BEV feature map 235 from the transformer module 213 to output an updated BEV feature map 237. The post processing subsystem 250 may further process the updated BEV feature map 237 and can model inter-ray regularities that the ray-wise transformer may not deal with.

In another aspect, the base architecture is augmented with an auxiliary supervision of additional modality M^{aux} available during training. In an example implementation, a binary occupancy map is used, which is computed from privileged information in simulation. Hence, with augmentation of auxiliary output, the system can be formulated as, [\hat{M}^{zero}, \hat{M}^{aux}]=ϕ([I^{rgb}, I^{zero}]), with mapping ϕ trained with Dice loss for both predictions.

In another aspect, an inductive bias is introduced for the disentanglement between geometry and modality. For this setting, the base architecture in FIG. 2A is modified. Compared to the base architecture of FIG. 2A, it takes the input-output quadruplet including the auxiliary supervision [(\hat{M}^{zero}, \hat{M}^{aux}), (I^{rgb}, I^{zero})] and organizes it into two inputs: an RGB input predicting \hat{M}^{aux} from I^{rgb} and a zero-shot modality input. The RGB input, I^{rgb} 105 may be fed to the feature extractor 210 that, by incorporating a first transformer module similar to the base transformer module 213, generates initial BEV feature maps 235. The other input is zero-shot modality input I^{zero} 205 that is processed by the second network 214 to generate feature maps, but these feature maps are not channel concatenated with the ones from I^{rgb} 105 input. However, these feature maps are also fed to a second transformer module. In other words, feature maps from both the inputs are separately projected to BEV plane using two transformer-based networks (per layer, one for each input). Each such pair of transformer networks may have a specific structure, for example, the one processing RGB features may have the same structure as the base model. While the other, processing the features from I^{zero} 205 may be forced to have the same cross-attention but the value projection may be set to the “Identity” matrix. This may be done to encourage the zero modality to not modify the value of the input I^{zero} 205 image and use the same FPV to BEV transformation as of the RGB modality.

Hence, with the inductive bias having two separate input streams, there are two sets of initial BEV features. These two sets of initial BEV features from RGB and zero modalities may be concatenated along the channel dimension. The stacker 225 stacks the initial BEV feature maps 235 in polar coordinates to the updated BEV map 237 in cartesian coordinates. After the BEV feature map is generated in polar coordinates, it is converted to cartesian BEV coordinates using an affine transformation. Subsequently, this updated BEV feature map 237 may be converted to a usable BEV map 265 through a post-processing subsystem (decoder) 250. In one embodiment, the initial BEV feature maps 235 may be fed directly into a post-processing subsystem 250 that is trained to receive feature maps without having been stacked by stacker 225.

The post-processing subsystem 250 may receive the initial BEV feature map 235 of the zero-shot stream and may determine the corresponding BEV map \hat{M}^{zero} 265a (left) to the FPV image 105. In some aspects of the present disclosure, the post-processing subsystem 250 further determines one or more auxiliary outputs corresponding to the FPV image 105. Particularly, the post-processing subsystem 250 may utilize one or more machine-learning models to determine the zero-shot and auxiliary outputs, generating outputs \hat{M}^{zero} 265a (left) and \hat{M}^{aux} (i.e., 265b (left), and 265c (left)), respectively. By way of example, two auxiliary outputs (i.e., 265b and 265c (left)) are illustrated in FIG. 2C that refers to the two augmented auxiliary modality streams from two modal images (e.g., navigation (265b) and obstacles (265c)). In some aspects of the present disclosure, the post-processing subsystem 250 may be configured to determine one or more auxiliary outputs corresponding to the FPV image (along with additional modal image) that may be used to refine training of the post processing subsystem 250 for generation of the BEV map 265a (left). Auxiliary outputs (e.g., 265b (left) and 265c (left)) are not trained for zero shot.

The post-processing subsystem 250 may utilize the zero-shot stream using one or more machine-learning (ML) and/or data optimization techniques to generate (or predict) the BEV map 265a (left). In an example implementation, the one or more ML models is a U-Net CNN based decoder. In some aspects of the present disclosure, the one or more ML models may be trained by training module 113 using training data 114 for determination of auxiliary losses from a data input that enables the one or more ML models to determine (predicted) BEV map 265a (left) and the auxiliary outputs 265b (left) and 265c (left), which may be compared during training with their ground truth (GT) 265a (right), 265b (right), and 265c (right), respectively. Typically, there may exist one or more additional loss terms during training of the one or more ML models that minimizes a reconstruction error of auxiliary channels. The auxiliary outputs may provide additional training to the one or more ML models. The trained one or more ML models, by way of the zero-shot stream may enable prediction of the BEV map 265a (left) associated with the FPV image 105.

Furthermore, the post-processing subsystem 250 may determine the output 265a (left) corresponding to the updated BEV feature maps 237. In an alternate embodiment, the post-processing subsystem 250 may determine the output 265a (left) corresponding to the initial BEV feature maps 235. The post-processing subsystem 250 may also generate the auxiliary outputs 265b (left) and 265c (left) based on the updated BEV feature map 237.

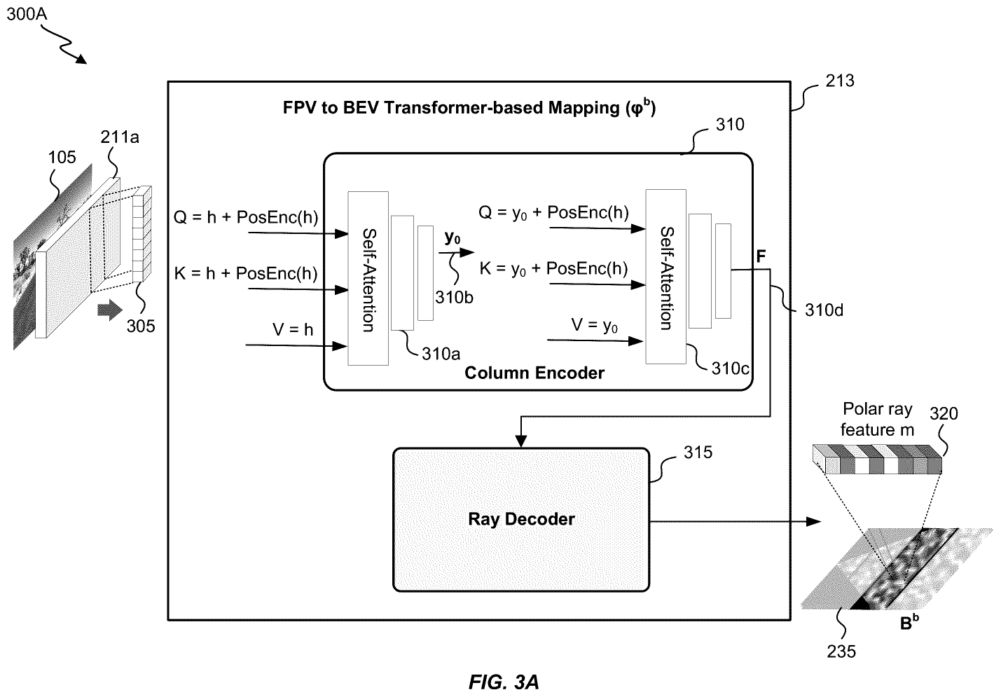

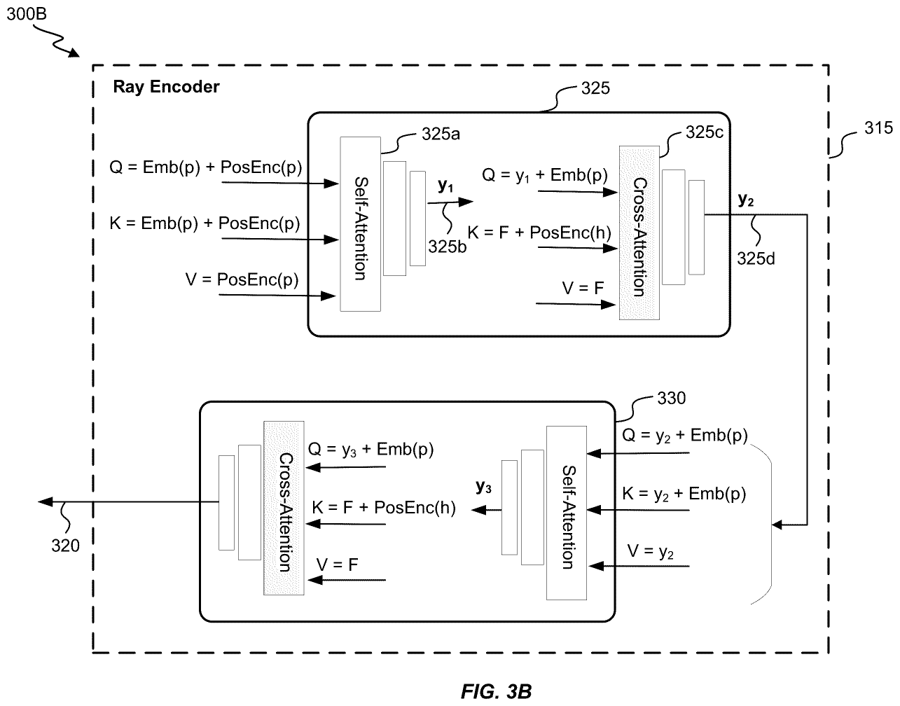

FIG. 3A illustrates an example block diagram including one or more components of a subsystem from the FIG. 2A. The system 300A includes one or more transformer-based modules 213, each operating independently on a different slice of the FPV image to BEV maps. The one or more transformer modules 213 are applied column-wise to map the values in each column 305 of the FPV image 105 to a BEV polar ray m 320 (so in polar coordinate system) in the corresponding BEV region B. The transformer module 213 may receive the tensors H^{b} and apply mapping to transform it to BEV plane. Each tensor (e.g., H⁰ 211a, H¹ 211b, H² 211c, H³ 211d) may be mapped independently by the one or more transformer modules (e.g., 213a, 213b, 213c and 213d) to a respective BEV band B^{b} (e.g., 235a and 235b, 235c and 235d), respectively, covering a predefined depth range of the BEV. This mapping may need to assign a position in polar coordinates in the BEV band B for each cartesian coordinate (x, y) in the FPV tensor H. The transformer module 213 may determine the correspondence between the FPV image feature column h 305 and the BEV polar ray m 320 by a correspondence function.

In some aspects of the present disclosure, the correspondence function may be dependent on a set of intrinsic parameters (e.g., focal length, principal point, or distortion coefficients) of the camera unit coupled with the sensing unit 115 for capturing the FPV image 105. The transformer module 213 may perform FPV image 105 to BEV plane correspondence calculations by a sequence of self-attention and cross attention operations (metrics) based on the set of intrinsic parameters. Based on the correspondence, the transformer module 213 may project (or map) the set of tensors (e.g., 211a and 211b) to generate the initial BEV feature map 235.

The one or more transformer modules 213 may include a column encoder 310 and a ray decoder 315 to generate an initial BEV feature map 235. The column encoder 310 may receive a tensor 211a from the feature extractor 210 and compute the self-attention for each column h E R^{S×R}. The column encoder may include one or more layers of self-attention modules with one or more attention heads. In an example implementation, self-attention is computed with two-layer transformer encoders (i.e., 310a and 310b) architecture with four attention heads. Each encoder layer may process its inputs through the one or more layers of a dropout and normalization layers. The sinusoidal position encoding (referred to as “PosEnc” in FIG. 3A) may be added to each input of each multi-head attention layer. For each column h, the output of the column encoder is a contextualized feature column 310d F∈R^{S×R}.

The functional form of the transformer block 213 can be explained by decomposing the tensor H into columns and the BEV image M into polar rays for solving the assignment problem pixel height y↔cell radius ρ on ray for each pair (column, ray) individually. In other words, the mapping of a column h∈H to a ray m∈M. Each element h_{y} of column h is a feature vector corresponding to a position y in the column, and each mₚ is the map element on position ρ of the ray, whose positional encoding is denoted as p_{ρ}.

The assignment problem may be solved through query-key-value cross-attention, where positional encodings p_{ρ} on the ray query into the possible positions h_{y} on the column can attend to with projections Q=p_{ρ}^{T}W_{Q}, K=h_{y}^{T}W_{K}, V=h_{y}^{T}W_{V}, where W_{Q}, W_{K}, W_{V} are trainable weight matrices. For each attention head, this may lead to an attention distribution α_{ρ}={α_{y}, ρ} for each query ρ over attended column positions y, calculated classically as in transformer models, as:

$${α}_{y , ρ} = \frac{exp {e}_{y , ρ}}{{\sum }_{k} exp {e}_{y , ρ}} , = \frac{{( {{p}_{ρ}}^{T} {W}_{Q} )}^{T} ( {{h}_{y}}^{T} {W}_{K} )}{\sqrt{D}}$$

The resulting cell content m_{ρ} of the BEV map may be then weighted by attention as, m_{ρ}=Σ_{y}α_{y,ρ}·V, where multi-head attention, feed-forward and normalization layers notations are ignored for simplicity.

FIG. 3B illustrates an example block diagram 300B including one or more components from the FIG. 3A. The output F 310d of the column encoder 310 is fed into the ray decoder 315 that includes one or more layers of decoder networks. In an example implementation, two layers of decoder network are deployed (i.e., 325 and 330). The ray decoder may transform the FPV contextualized feature column F 310d into a BEV ray feature m∈R^{S×P}, where P is the desired ray dimension of the BEV band (235a or 235b). The decoder may get as input the P target positions in the BEV ray as p, encode them through one or more trainable embedding layers (referred to as “Emb(p)” in FIG. 3B) and add to them sinusoidal positional encodings. The mapping may be performed by one or more transformer decoder layers, each comprising of one or more self-attention blocks 325a and one or more cross-attention layers 325c between the ray self-attention output and the contextualized column feature F 310d. Each transformer decoder layer (325 and 330) may have one or more of other layers, for example, dropout layers and normalization layers. This process may lead to the BEV ray feature tensor m∈R^{S×P} 320. At this point, each FPV image column h 305 is mapped to a corresponding BEV polar ray m 320. All rays 320 corresponding to all columns of a tensor H are stacked together along the polar dimension θ to form the 2D polar feature map B (e.g., 235a), which may be converted to a rectilinear BEV band through an affine transformation. All of the bands may be stacked together along the ray dimension ρ and then resampled to cartesian coordinates by stacker 225 to obtain the BEV feature map M^{feat}∈R^{S×P′×C′} 237 as illustrated in FIG. 2A. Here P′ and C′ are the dimensions of the updated BEV feature map M^{feat} 237, which is same as residual feature map, M^{zero} 230.

In an example implementation, training is aimed to understand or untangle the information related to scene geometry and the information related to the modality used in projecting FPV image 105 to a BEV map 110. During training, this disentanglement may be achieved through a dedicated loss combined with synthetically generated data with targeted statistical properties. The FPV image I^{rgb} 105 may be combined with a synthetic pseudo-random zero-shot data stream I^{zero} i.e., input pairs with the output M^{zero} leading to data triplets (I^{rgb}, I^{zero}, M^{zero}) as is done in base architecture. In an example embodiment, the data triplets have the three key properties. A first property of the data triplet is, the two streams (i.e., I^{rgb} and I^{zero}) are geometrically aligned. In other words, for each sample, I^{zero} is taken from the same viewpoint as I^{rgb} 105. A second property of the data triplet is that the output BEV maps 110 M^{zero} (which are only available for training) are defined by geometric transforms (i.e., FPV to BEV) and that are overlaid with a synthetic texture using the ground-truth 3D scene structure.

FIG. 4 illustrates an example of a data generation process by procedurally projecting generated random textures 405 (i.e., patterns) onto a 3D scene structure 410. The generated texture mesh is rendered into image pairs (I^{rgb} 105 and I^{zero} 205) with perspective and orthographic projections, respectively. This structure and overlaid textures may be used to generate input-output pairs through perspective and orthographic projections to obtain the FPV image I^{zero} 205 and BEV map M^{zero} 415, respectively. A third property of the data triplet is that the content of the zero-shot stream is decorrelated from the content of the primary stream up to the 3D scene structure. To be more precise, the texture on the 3D scene structure is binary, pseudo-random, procedurally generated, and does not depend on the scene properties.

More specifically, FIG. 4 illustrates an example data generation process for generating a set of data triplets (I^{rgb}, I^{zero}, M^{zero}) for training the models of the base architecture of the projection module 120, wherein each data triplet is generated by (i) generating a 3D scene mesh structure 410; (ii) from a FPV position in the 3D scene mesh structure, recording a FPV image I^{rgb} 105, (iii) applying a synthetic texture 405 to the 3D scene mesh structure 410, (iv) from the FPV position in the 3D scene mesh structure 410 with the applied synthetic texture 405, recording a FVP modal image I^{zero} 205, (v) from a BEV position in the 3D scene mesh structure 410 with the applied synthetic texture 405, recording a BEV feature map M^{zero} 415, wherein the FVP modal image I^{zero} 205 and the BEV feature map M^{zero} 415 represent the same scene, and wherein the synthetic texture 405 is decorrelated from the scene.

In an example implementation, data triplets (I^{rgb}, I^{zero}, M^{zero}) are used for training the mapping function ϕ, as illustrated in FIG. 2. The process can be formulated in equation as: \hat{M}^{zero}=([I^{rgb}, I^{zero}])=ϕ′, where the image pairs in square brackets represents image channel concatenation. The network may be trained with Dice loss. When testing is done in zero-shot settings, the input pair is mapped to the output \hat{M}^{zero} as discussed above.

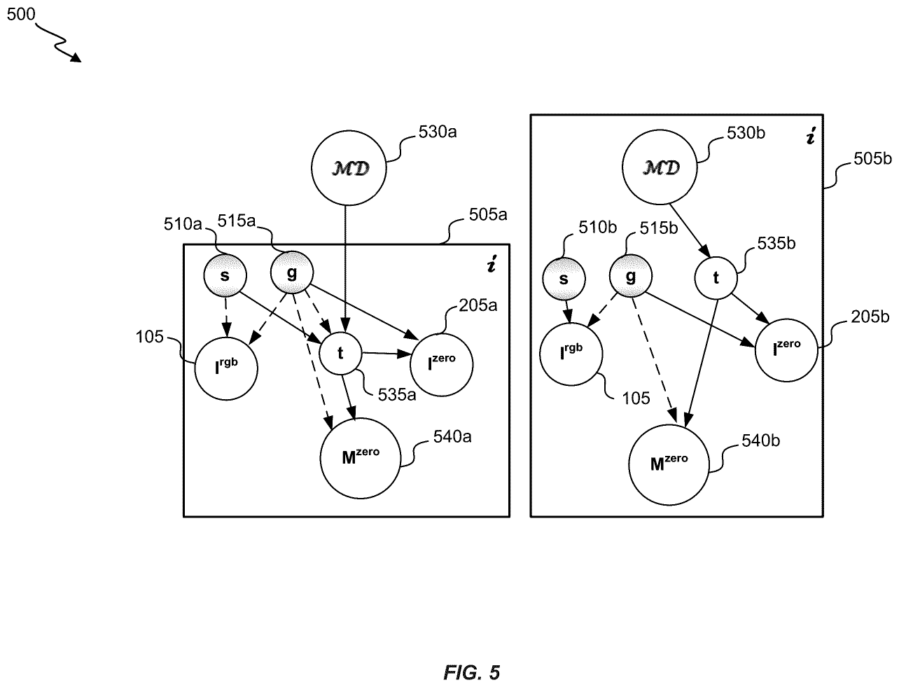

FIG. 5 illustrates a casual model of a data generation process in accordance with an embodiment of the present disclosure. The third property of the data triplet may play an important role in design choices for learning correct entanglement (i.e., having a common scene geometry in input image I^{rgb} and the modal image I^{zero} yet decorrelated modalities) during training. It may be easier to choose an available modality as training zero-shot data instead of pseudo-random data, for instance semantic segmentation available on Habitat-Matterport semantics (HM3DSem) dataset. However, this may introduce regularities in the input pair (I^{rgb}, I^{zero}) due to correlations caused by the confounding scene structure and semantics. This can be formalized in a causal model of the data generation process, as shown in FIG. 5. For each training sample i 505a, the input image I^{rgb} 105 may be dependent on scene geometry g 515a (including viewpoints) and on scene semantics s 510a (including material properties etc.). Confounder variables, related to both the independent variables (being observed or manipulated i.e., I^{rgb} 105) and the dependent variable (output M^{zero} 540a), are scene geometry g 515a and scene semantics s 510a. Such confounding variables may lead to a misinterpretation of results as the impact for these may not be properly accounted for.

The BEV output M^{zero} 540a may also depend on the modality definition (MD) 530a, which influences the “texture” t 535a on the 3D geometry projected to the ground. Referring to the illustrative example of FIG. 5, the block 505a refers to the training example i. This block suggests a model when during training MD is fixed to a semantically meaningful modality, e.g., occupancy or semantic segmentation. In this context, the texture t 535a depends on the scene properties (s 510a, g 515a) leading to unwanted confounders between input I^{rgb} 105 and output M^{zero} 540a, decreasing the role of I^{zero} 205a. In this training model, I^{zero} 205a may become unnecessary to predict M^{zero} 540a, making zero-shot predictions not only degraded but also difficult. In an aspect of the present disclosure, the modality definition (MD) 530b varies over samples i 505b and is independent of scene properties (s 510b, g 515b). The only confounder between I^{rgb} 105 and output M^{zero} 540b is scene geometry g 515b, therefore texture t 535b is necessary for the prediction of M^{zero} 540b. This may lead to correctly taking into account I^{zero} 205b to learn the mapping ϕ, avoiding the exploitation of undesired shortcuts.

### Example Implementation

An example implementation of the disclosed method to project first-person view (FPV) images to bird-eye view (BEV) maps is provided. For data generation, the Habitat simulator is used to render views of the Habitat-Matterport semantics (HM3DSem) dataset of three-dimensional (3D) scenes. The HM3DSem dataset comprises 145 train scenes and 36 validation scenes. Out of 36 validation scenes, 4 scenes are used for validation and the remaining 32 for testing. The BEV semantic segmentation task is targeted using 8 semantic categories: “chair”, “sofa”, “bed”, “potted plant”, “toilet”, “tv”, “wall” and “floor”. For each scene, 2000 tuples are collected from two points of views: FPV images captured with a pinhole camera with resolution 384×384 and field of view (FOV) 79°, and top-down BEV maps of size 100×100 captured with an orthographic sensor over the FPV position and facing down, covering an area of 5 m×5 m in front of the FPV sensor. Top-down orthographic depth images are thresholded at a fixed value to generate navigable and obstacle BEV maps used as optional auxiliary modalities. All BEV maps are masked with the FPV FOV, estimated by projecting the FPV depth to the ground and computing its convex hull.

For training, a batch size of 16 is used with Adam optimizer and initial learning rate lr=1e⁻⁴ with 0.9 exponential decay and halving of lr on plateau of validation performance. Results for this method are summarized in TABLE 1(c).

TABLE 1
Zero-shot performance of different methods, reporting IoU on test semantic BEV images unseen during training.

| Method | # of Params. | Training set size | Wall | Floor | Chair | Sofa | Bed | Plant | Toilet | TV | Avg. | Pix Avg. |
|---|---|---|---|---|---|---|---|---|---|---|---|---|
| (a.1) P⁻¹ w. | 0 | — | 14.8 | 32.3 | 41.4 | 43.2 | 36.0 | 45.0 | 21.3 | 28.7 | 32.8 | 42.7 |
| GT depth | | | | | | | | | | | | |
| (not comp./ | | | | | | | | | | | | |
| Oracle) | | | | | | | | | | | | |
| (b.1) VPN | 15M | 290k | 3.7 | 61.9 | 15.0 | 26.4 | 35.9 | 7.0 | 13.8 | 6.6 | 21.3 | 61.1 |
| (not comp/not | | | | | | | | | | | | |
| zero-shot) | | | | | | | | | | | | |
| (b.2) TIM | 41M | 290k | 5.8 | 67.5 | 21.3 | 30.5 | 39.5 | 9.8 | 16.2 | 7.0 | 24.7 | 64.9 |
| (not comp/not | | | | | | | | | | | | |
| zero-shot) | | | | | | | | | | | | |
| (b.3) TIM w. | 41M | 290k | 7.4 | 69.7 | 30.2 | 42.3 | 46.3 | 15.5 | 20.6 | 11.0 | 30.4 | 68.3 |
| Sem. Seg. (not | | | | | | | | | | | | |
| comp/not | | | | | | | | | | | | |
| zero-shot) | | | | | | | | | | | | |
| (a.2) P⁻¹ w. | 123M | 12M + 1M | 9.8 | 32.2 | 26.0 | 34.7 | 31.1 | 18.1 | 15.2 | 15.6 | 22.8 | 39.7 |
| learned MDE | | | | | | | | | | | | |
| (c) Zero-BEV | 41M | 290k | 8.1 | 58.4 | 23.6 | 35.5 | 35.1 | 11.5 | 13.3 | 7.8 | 24.2 | 58.2 |
| (+aux) | | | | | | | | | | | | |
| (d) Zero-BEV | 123M + 41M | 12M + 1M + 290k | 12.1 | 58.2 | 27.5 | 39.9 | 39.8 | 16.9 | 14.5 | 12.4 | 27.7 | 58.9 |
| (+aux, | | | | | | | | | | | | |
| residual) | | | | | | | | | | | | |

In this example implementation, the feature extractor ψ 212 is a pretrained ResNet50 followed by a feature pyramid to extract FPV feature maps at four resolutions. As in, each FPV feature map is projected to BEV band 235 independently using the transformer-based network ϕ 213 and concatenated to form a BEV feature map (M^{feat}) 235 of size 256×100×100. This is processed by a small U-Net as a post-processing subsystem 250 to generate \hat{M}^{zero} 265a (left) and optionally \hat{M}^{aux} 265b (left) and 265c (left). The model is trained with Dice loss (L_{D}), averaged over K classes, computed as:

$${L}_{D}^{K} = 1 - \frac{1}{K \vert} {\sum }_{k = 1}^{K} \frac{2 {\sum }_{n}^{N} {g}_{n}^{k} \cdot {p}_{n}^{k}}{{\sum }_{n}^{N} {g}_{n}^{k} + {p}_{n}^{k} + ε} ,$$

where N is the number of pixels in the BEV maps, gₙ^{k} is the ground-truth label for pixel n of the BEV map for class k. If the pixel n belongs to the class k, gₙ^{k}=1, otherwise, it is zero. Similarly, pₙ^{k} is the binary model prediction for pixel n and class k. Finally, ε is small constant to avoid division by zero.

For exploring the zero-shot data stream for training, three different variants of the present technique are explored. The variants are explored in different data generation methods related to zero-shot data stream used for training. The three different variants include synthetic (hereinafter as, “Synth”), modal semantics (hereinafter as, “ModSem”) and depth projection (hereinafter as “DepthProj”). Synth is the main variant that is used for all the results presented in this disclosure, and the other two variants, ModSem and DepthProj, are discussed in the ablation study summarized in TABLE 5. All the BEV maps, including the zero-shot ones described below, are masked with the FOV of the FPV sensor projected to the BEV map to make reconstruction possible. This mask is computed with a process similar to the one described in FIG. 2B. FPV depth is expanded into a 3D point-cloud of the scene, quantized in a voxel representation and projected to the ground by max pooling along the height dimension (again, only considering heights lower than 2 m). Finally, the FOV mask is generated by computing the convex hull of this BEV projection.

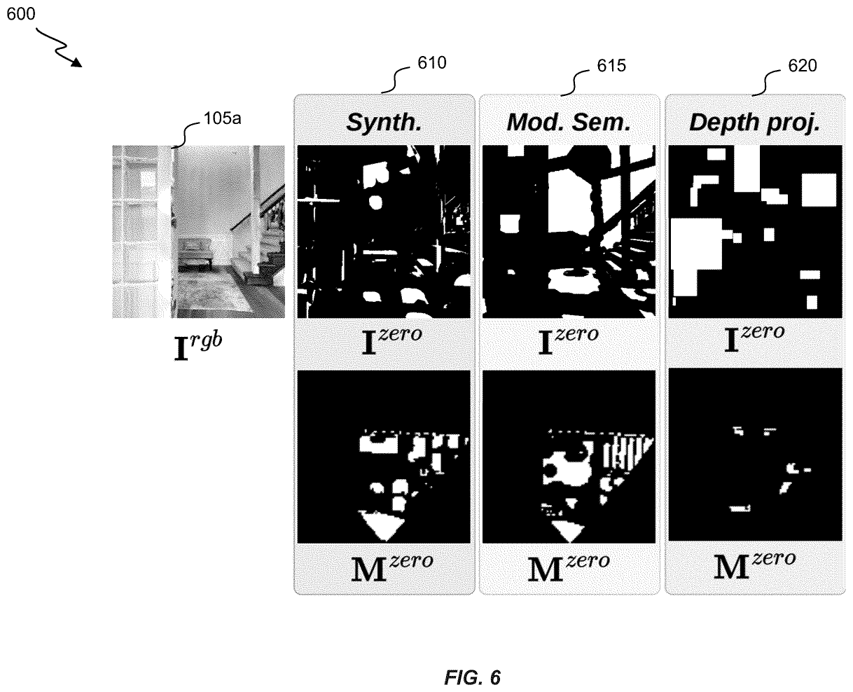

FIG. 6 illustrates training triplets (I^{rgb}, I^{zero}, M^{zero}) 600 for three different zero-shot data variants in accordance with an example implementation. The procedure of the zero-shot data generation process for the Synth 610 and ModSem 615 variants are similar. In both cases, two-dimensional (2D) textures are generated and projected to the 3D scene structure, which can be further projected to FPV and BEV through perspective and orthographic projections, as described above. This procedure produces a pair of FPV image I^{zero} and BEV map M^{zero} e.g., (615 and 610) aligned with the observations captured with the standard process described above.

Synth (610)—this is the main variant. This process starts with blank, e.g., completely black, texture images of the size of the initial semantic texture image present in the original GLB file. Then, random binary structures are created by randomly selecting texture images from the describable texture dataset (DTD) and applying randomly resizing and thresholding. The morphological opening is applied on these images with a random kernel shape among [ellipse, square, cross] and random kernel size s∈[10, 30] pixels. The resulting structure is added to the texture image used in the modified GLB file. This process is repeated, adding structures until a certain proportion of white pixels is present in each texture image, 5% in these example implementations. Finally, morphological dilation is recursively applied with random kernel size s∈[10, 30] pixels to the structures present in the texture until the desired proportion of white matter, from 10% to 30% with intervals of 5% in these example implementations, is obtained. It is worth stressing that this process generates textures 610 (top) whose appearance is decorrelated from the scene geometric structure, as described in FIG. 2. The only correlation to the RGB input 105a is up to the scene geometry, which is desired, and arises when the textures are projected on the scene 3D structure.

ModSem (615)—these data are generated deliberately somewhat violating decorrelation property, to validate its importance. In this case, the original semantic textures in the original GLB files are considered, thus not discarding but binarizing these (so all scene objects become white) and recursively applying morphological erosion with a random kernel shape among [ellipse, square, cross] and random kernel size s∈[10, 30] pixels, until the desired proportion of white matter is obtained, from 10% to 30% with intervals of 5% these example implementations. In this case, the resulting texture appearance 615 (top) exhibits significantly more correlation with the scene geometry as illustrated in FIG. 6. This may imply that part of the information needed to reconstruct M^{zero} 615 (bottom) is already contained in the I^{rgb} 105a, decreasing the importance of I^{zero} 615 (top). This may result in lower zero-shot performance, as shown in TABLE 5.

Depth Proj (620)—this third variant uses data generated in a different and somewhat simpler way. In this case, the scene meshes are not modified, instead a synthetic FPV image I^{zero} is taken and created by adding a random number n∈[10,20] of white rectangles of random size and shape at random positions over a black image. This I^{zero} is projected to BEV using ground-truth depth and the same process used to generate [symbol] . FPV depth is projected onto a 3D point-cloud, quantized, and projected to the ground by max-pooling along the height dimension (only heights lower than 2 m). While I^{zero} 620 (top) is clearly decorrelated from scene structure as shown in FIG. 6, the BEV zero-shot data generation process relies entirely on FPV depth for the projection to the ground. This implies that the model cannot learn to infer BEV details that are not present in FPV images.

For mapping 2D→3D, a function that assigns 2D positions in the 2D texture files to 3D positions in the scene structure is utilized. Given the pseudo-random nature of this function, its exact properties are not important. Therefore, existing projections from the HM3DSem dataset are used where graphic language transmission format binary (GLB) files include 3D textured meshes e.g., 3D triangle meshes, associated 2D textures, and texture mapping data. The GLB is a standardized file format used to share 3D data. From these files, the 3D scene structure and the mapping functions are kept, but the 2D textures are replaced, replacing the semantic annotations with pseudo-random data. The difference between these two variants lies in the way the mesh textures are generated.

In an example implementation, when training zero-BEV without the one or more auxiliary outputs, there is only one class to predict in the zero-shot stream, and the loss is simply expressed as L_{D}^{zero}=L_{D}¹. When using the auxiliary data stream, an auxiliary loss L_{D}^{aux} is added, which for the best performing model include K=2 classes, navigable and obstacle. The final loss then becomes L_{D}=(1−α). L_{D}^{zero}+α·L_{D}^{aux}, where α=0.5 in all these example implementations. Changing the value a may not impact the loss significantly.

Closely related to the Dice loss, zero-shot semantic BEV prediction performance are measured in terms of class intersection over union (IoU) and pixel IoU. Class IoU is computed as the ratio between the area of the region where ground-truth and predicted semantic masks for a given class coincide (intersection), and the area of the region where either of the two predict a detection (union): IoU=|GT∩P∥G∪P|, where G is the ground-truth binary semantic BEV mask of the class at hand and P is the predicted network output, followed by a sigmoid and thresholded at 0.5. There is a slight difference with the Dice loss, which in this notation is expressed as 1−2·|GT∩P|/|GT|∪|P|. While the average class IoU weights classes equally, assessing how many pixels are correctly classified overall is also a concern. For this, Pixel IoU is computed, as the cumulated area of all the intersections for all classes and test images, divided by the cumulated area of all unions for all classes and test images. In all the tables, the values listed are calculated with respect to the mentioned metrics i.e., IoU.

The comparison of the present technique with baselines and different variants is also performed. A baseline approach for projecting FPV to BEV is inverse projection and pooling to ground using depth of FPV semantic segmentation. In TABLE 1, this technique is divided into two variations: (i) using ground-truth depth from Habitat simulator—TABLE 1(a.1); (ii) Omnidata normalized MDE model, finetuned on a custom dataset of 1 M RGB-depth image pairs from HM3D for metric MDE—TABLE 1(a.2).

The second baseline approach for projecting FPV images to BEV maps is view parsing network (VPN), a non zero-shot method that does not use camera intrinsics. It is trained to predict target 8-class BEV semantic maps—TABLE 1(b.1). The third baseline method is translating images into maps (TIM), a non zero-shot learning method with architecture similar to the present technique and trained to predict the target BEV semantic maps—TABLE 1(b.2). Another model is trained with an additional input channel, the FPV semantic segmentation, so that it has the exact same information of zero-shot methods. This should represent an upper bound when it can be trained on the task but cannot be used for zero-shot projections of any modality. Results are in TABLE 1(b.3). The zero-BEV residual model may combine geometry with learning, concatenating BEV feature maps generated by the present approach and by projecting with the metric MDE model described above. The resulting features are processed by the same U-Net to zero-shot generate BEV maps. Results are displayed in TABLE 1(d). In TABLE 1, IoU is reported for the baseline techniques in two variants: averaging over classes and accumulating over pixels. The former weights classes equally, whereas the latter gives weights proportional to their appearance in the data.

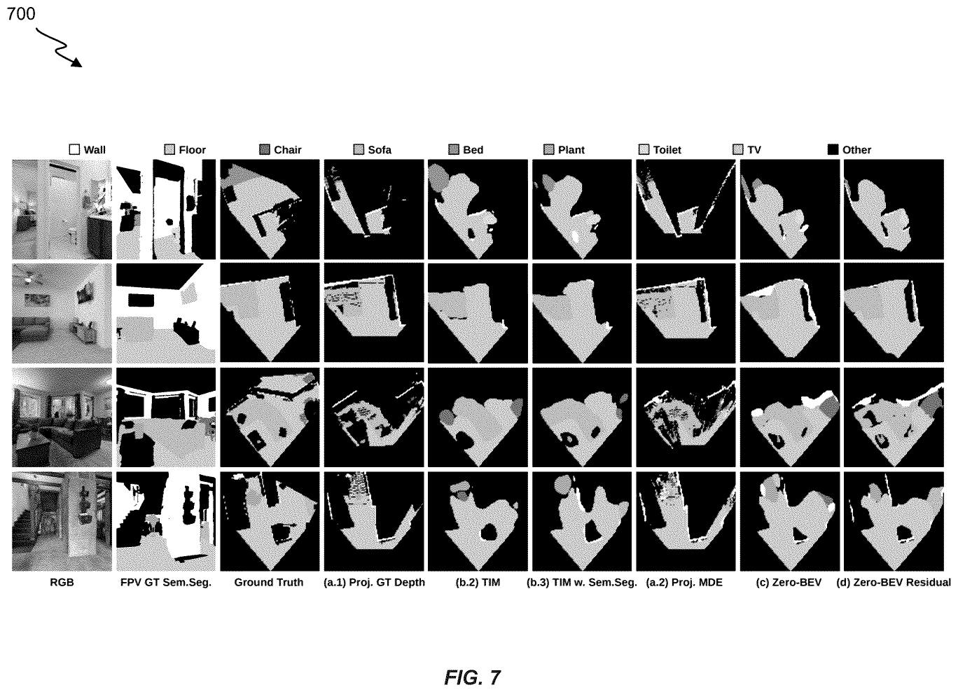

FIG. 7 illustrates qualitative results on a Habitat-Matterport semantics dataset (HM3DSem), in accordance with an example implementation of the present disclosure. Qualitative examples, as given in FIG. 7, illustrates projections using depth, either ground-truth FIG. 7(a.1) or estimated with MDE FIG. 7(a.2) are precise on walls and fine structures, but suffer from typical artefacts such as holes and depth quantization noise. Fully supervised TIM, FIGS. 7(b.2) and 7(b.3), can infer regularities in top-down maps. As expected, FPV semantic segmentation, available to FIG. 7(b.3), enhances BEV map quality. Zero-BEV FIG. 7(c) appears qualitatively close to its non zero-shot counterparts. Zero-BEV residual FIG. 7(d) even seems to improve over TIM variants, exploiting geometric projection for fine elements and learning to regularize BEV structures, and going as far as correcting small inaccuracies in ground-truth labels (e.g., the left-most wall on the bottom example).

For each sensor, RGB image (I^{rgb}) 105, depth and semantic annotations are recorded. For FPV, this allows to create I^{rgb} 105, ground-truth (GT) semantic segmentation masks used as I^{zero}) 205 in the zero-shot experiments reported in TABLE 1 and shown in FIG. 7, and ground truth depth used for baseline (a.1) in TABLE 1. From the orthographic images, GT semantic BEV maps, used for evaluation only in the zero-shot experiments and shown in FIG. 7, and BEV depth, which is thresholded at 10 cm from the floor level to obtain GT navigable and obstacle BEV maps, Mₙₐᵥ^{aux} and M_{obst}^{aux}, optionally used for training. In TABLE 1, the best values for zero-shot methods are in bold, second best are underlined. Other approaches are not comparable because they use Oracle data or are not zero-shot capable. Methods (a.2) and (d) use monocular depth estimation (MDE), i.e. additional 12 M (×10⁶) image tuples for training+1 M RGB-depth image pairs for finetuning.

Comparisons with baselines and state-of the-art (SOTA) techniques are given in TABLE 1 for projections of semantic segmentations taken from HM3DSem dataset. Zero-BEV (c) outperforms the geometric zero-shot capable baseline (a.2), which resorts to inverse perspective projection with learned depth, on both metrics, class IoU (denoted in TABLE 1 as Avg.) and pix IoU (denoted in TABLE 1 as Pix Avg.) and using both the pure and the residual variants. The biggest gains occur for the floor class, which can be explained by the power of the end-to-end trained model to infer unseen and occluded floor space, but big gains are also obtained for wall, chair, sofa, and bed. Interestingly, on the pixel IoU metric zero-BEV even outperforms the projection with ground-truth depth, and examples in FIG. 7 make it clear why projecting only observed information from FPV to BEV leaves a large number of holes in the map. The end-to-end trained methods, TABLE 1(b.*), are not zero-shot capable as they have been trained for the target modality for which we evaluate—the numbers are given for information. Compared to these well-received methods, zero-BEV adds zero-shot capabilities and thus new applications. Interestingly, zero-BEV outperforms VPN on class IoU and is not far in pixel IoU. The residual variant TABLE 1(d) boosts the performance of Zero-BEV mostly on smaller classes and even outperforms a state-of-the-art non zero-shot method like TIM. Referring to FIG. 7, visually illustrates how this model obtains hints of the presence of smaller structures from the geometric mapping and is capable of expanding on them. The (*), as used herein refers to the inclusion of all approaches that start with the specified letter, for example, (b*) refers to b.1, b.2, b.3.

Impact of auxiliary loss is given in TABLE 2(c.*). Compared to the base variant of TABLE 2(-), the auxiliary loss mainly adds reconstruction quality for smaller semantic classes and does not seem to be responsible for the power to infer unseen information. The usage of different modalities can be explored as choice of the binary auxiliary signal and report slight differences. For the residual model TABLE 2(d.*), auxiliary losses also boost mean performance and impact most classes. In TABLE 2, the shaded rows are copied from TABLE 1.

TABLE 2
A comparison table exploring the impact of auxiliary loss supervising a binary
channel defined in different ways, and the impact of the inductive bias.

| Method | Wall | Floor | Chair | Sofa | Bed | Plant | Toilet | TV | Avg. | Pix Avg. |
|---|---|---|---|---|---|---|---|---|---|---|
| (—) Zero-BEV | 7.2 | 57.1 | 21.7 | 33.5 | 33.8 | 10.1 | 12.3 | 6.3 | 22.8 | 57.7 |
| (c) Zero-BEV + aux (=obstacles + | 8.1 | 58.4 | 23.6 | 35.5 | 35.1 | 11.5 | 13.3 | 7.8 | 24.2 | 58.2 |
| navigable) | | | | | | | | | | |
| (c.I) Zero-BEV + aux (=obstacles) | 8.1 | 58.3 | 23.5 | 35.7 | 35.3 | 10.9 | 12.0 | 6.8 | 23.8 | 57.1 |
| (c.II) Zero-BEV + aux (=navigable) | 8.0 | 58.0 | 23.0 | 34.9 | 34.9 | 9.9 | 12.2 | 5.9 | 23.4 | 57.8 |
| (d) Zero-BEV + aux (=obstacles + | 12.1 | 58.2 | 27.5 | 39.9 | 39.8 | 16.9 | 14.5 | 12.4 | 27.7 | 58.9 |
| navigable), residual | | | | | | | | | | |
| (d.I) Zero-BEV, residual | 10.9 | 51.2 | 23.9 | 36.2 | 34.8 | 16.8 | 14.7 | 14.4 | 25.4 | 53.9 |
| (e) Zero-BEV + aux (=obstacles + | 8.0 | 59.0 | 21.9 | 33.9 | 34.7 | 9.9 | 12.3 | 5.8 | 23.2 | 56.9 |
| navigable), inductive bias | | | | | | | | | | |

Impact of the inductive bias is explored in TABLE 2(e). The model is outperformed by the comparable variant TABLE 2(c), which is conjectured due to two properties: (i) the data is generated by max-pooling vertically to the ground, which is not covered by the disentangling property, (ii) restricting the cross-attention computations to geometry may help disentangling, but can potentially hurt the expressive power of the network, removing its capacity to model spatial regularities unrelated to the geometric mapping.

Training the residual model may require depth, which at training can be provided in different ways, investigated in TABLE 3. The network in the first row of TABLE 3 is trained using ground-truth from the simulator, the second row with depth estimated with the MDE model, and the third is trained first with GT and then MDE depth. All models are tested with MDE predicted depth. The third strategy achieves the best results.

TABLE 3
Training the residual model, which requires depth.

| Method | Wall | Floor | Chair | Sofa | Bed | Plant | Toilet | TV | Avg. | Pix Avg. |
|---|---|---|---|---|---|---|---|---|---|---|
| Ground-Truth (GT) | 11.2 | 57.4 | 26.0 | 39.2 | 38.5 | 16.9 | 15.5 | 15.2 | 27.5 | 56.8 |
| Predicted | 11.7 | 52.0 | 27.1 | 38.8 | 37.7 | 18.6 | 15.0 | 15.5 | 27.1 | 57.2 |
| GT Predicted | 12.1 | 58.2 | 27.5 | 39.9 | 39.8 | 16.9 | 14.5 | 12.4 | 27.7 | 58.9 |

TABLE 4 provides a sensitivity analysis of the amount of “white matter” (=pixels) in textures before mapping them on the 3D scene. Sensitivity is low, 20% was chosen based on avg. IoU.

TABLE 4
Data density

| Matter | Wall | Floor | Chair | Sofa | Bed | Plant | Toilet | TV | Avg. | Pix Avg. |
|---|---|---|---|---|---|---|---|---|---|---|
| 10% | 7.9 | 56.0 | 23.7 | 34.3 | 33.9 | 11.4 | 12.7 | 7.7 | 23.5 | 58.5 |
| 15% | 8.7 | 56.4 | 23.6 | 35.6 | 35.0 | 11.2 | 12.9 | 7.4 | 23.9 | 58.8 |
| 20% | 8.1 | 58.4 | 23.6 | 35.5 | 35.1 | 11.5 | 13.3 | 7.8 | 24.2 | 58.2 |
| 25% | 7.3 | 59.1 | 23.4 | 35.1 | 34.8 | 10.6 | 12.6 | 6.7 | 23.7 | 58.5 |
| 30% | 8.0 | 57.4 | 23.3 | 34.7 | 35.1 | 10.4 | 13.4 | 6.1 | 23.6 | 60.4 |

In TABLE 5, the IoU results for synthetic zero-shot data generation along with two alternative strategies (as described above) are listed. The first alternative to synthetic zero-shot data generation is based on modifying the existing HM3DSem textures corresponding to semantic labels (termed as ModSem), with the idea of generating distributions of 2D shapes. These 2D shapes are close to the existing scene structure, somewhat violating decorrelation property, and heavily modifying the textures with morphological operations. This leads to degraded performance, providing further evidence for the importance of decorrelation property as described above. The second alternative includes using ground-truth depth to project random binary shapes from FPV to BEV (DepthProj), which, as expected, behaves similarly to depth projection-based methods such as given in TABLE 1(a.*)—as it does not allow to learn inferring unseen BEV content from FPV images.

TABLE 5
Zero-shot data generation through three approaches

| Method | Wall | Floor | Chair | Sofa | Bed | Plant | Toilet | TV | Avg. | Pix Avg. |
|---|---|---|---|---|---|---|---|---|---|---|
| Synth (20%) | 8.1 | 58.4 | 23.6 | 35.5 | 35.1 | 11.5 | 13.3 | 7.8 | 24.2 | 58.2 |
| ModSem (30%) | 5.0 | 60.1 | 20.4 | 31.2 | 32.3 | 8.3 | 10.5 | 4.7 | 21.6 | 48.9 |
| DepthProj | 8.7 | 32.2 | 22.5 | 29.5 | 27.8 | 12.4 | 13.9 | 7.7 | 19.3 | 41.7 |

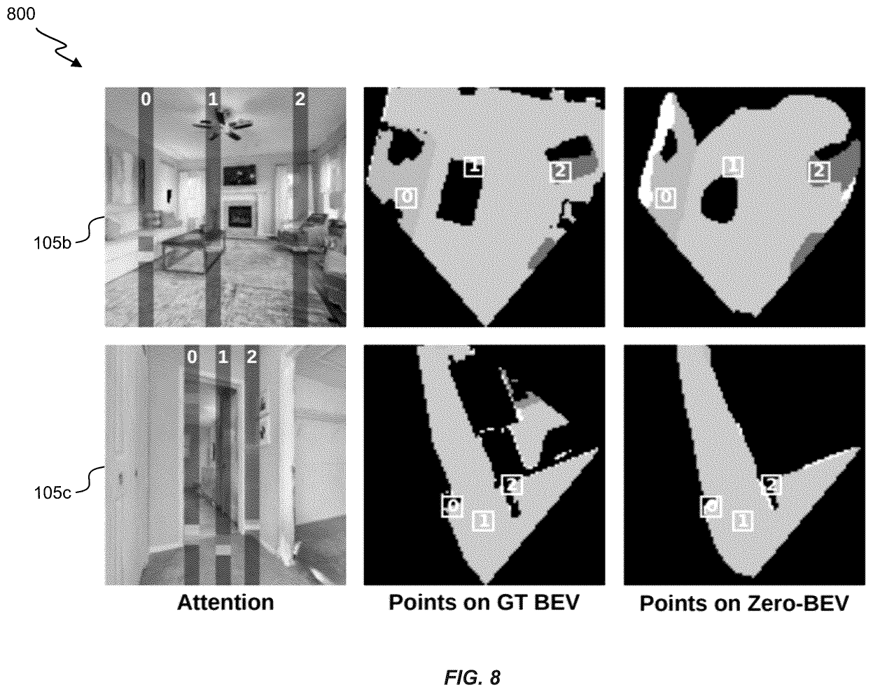

FIG. 8 illustrates visualizations of attention distribution, in accordance with an example implementation of the present disclosure. In FIG. 8, attention distributions are visualized for two example images (105b and 105c) and three selected map cells (e.g., ‘0’, ‘1’, ‘2’) for each image. Generally, attention focuses on vertical furniture boundaries, e.g., the sofa. Interestingly, the transformer attends to the floor even when the spot is occluded, as is the case for point ‘1’ in the top image (behind the table) and ‘2’ in the bottom image (behind the wall).

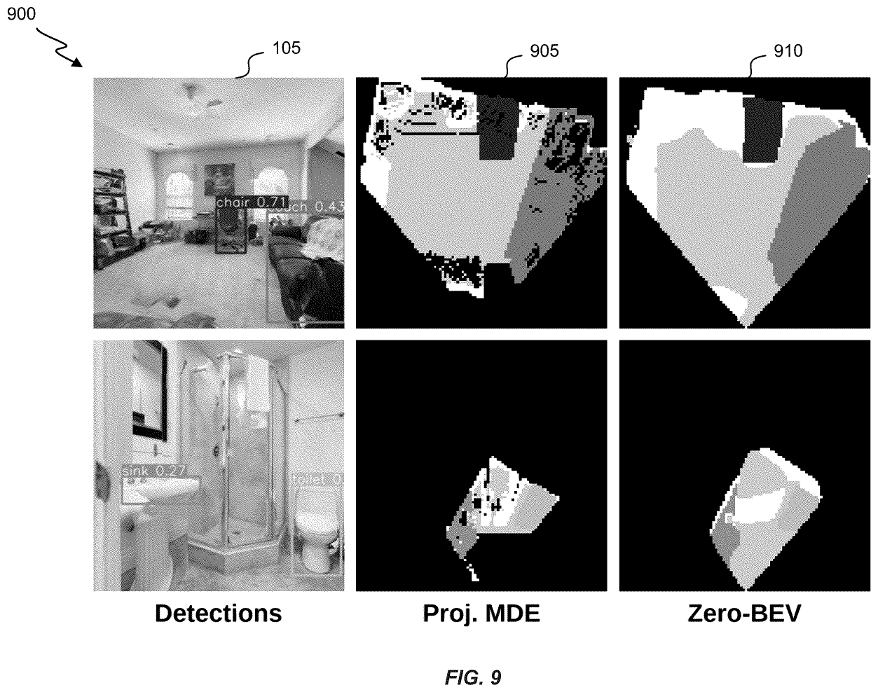

FIG. 9 illustrates zero-shot projections of objects in accordance with an example implementation of the present disclosure. Zero-shot projection of objects detected in the FPV images 105, geometric projection with learned depth 905, and projection with the present zero-BEV method 910. Additional zero-shot capabilities in FIG. 9, zero-shot project object bounding boxes are detected with YOLO in FPV image 105. Compared to the geometric baseline 905, the BEV maps 910 are cleaner and less noisy.

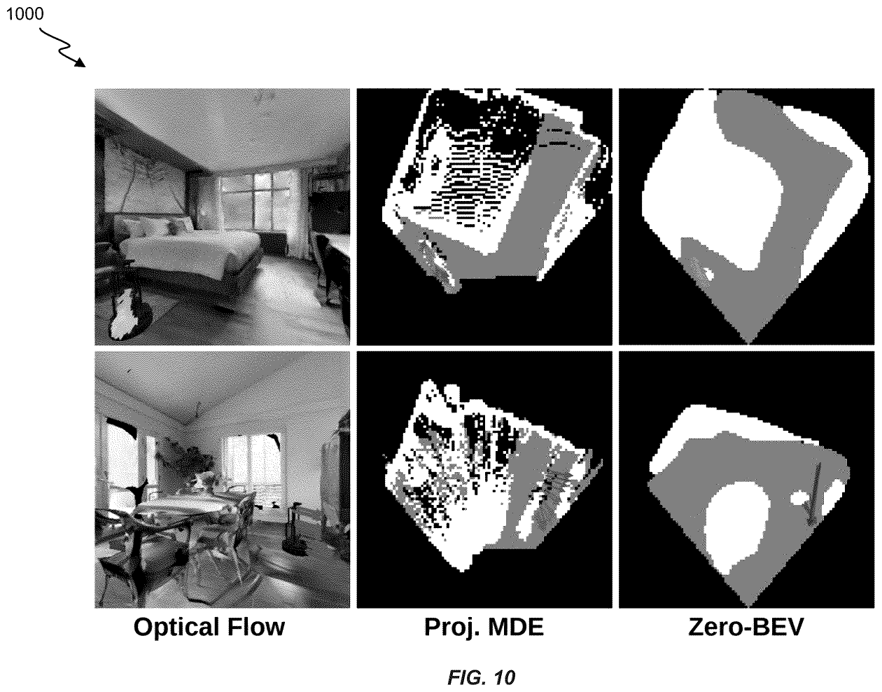

FIG. 10 illustrates optical flow calculated on an FPV pair (t, t=1) and displayed on frame t, in accordance with an example implementation of the present disclosure. In FIG. 10, zero-shot project optical flow is detected with RAFT. For each flow vector, two forward passes are performed for binary filled circles put on the starting point and the end point, respectively. Compared to the geometric baseline, the BEV flow vectors provided by zero-BEV are more accurate, which may be due to the difficulty of using geometric projections on finely structured moving objects, here the mobile robot.

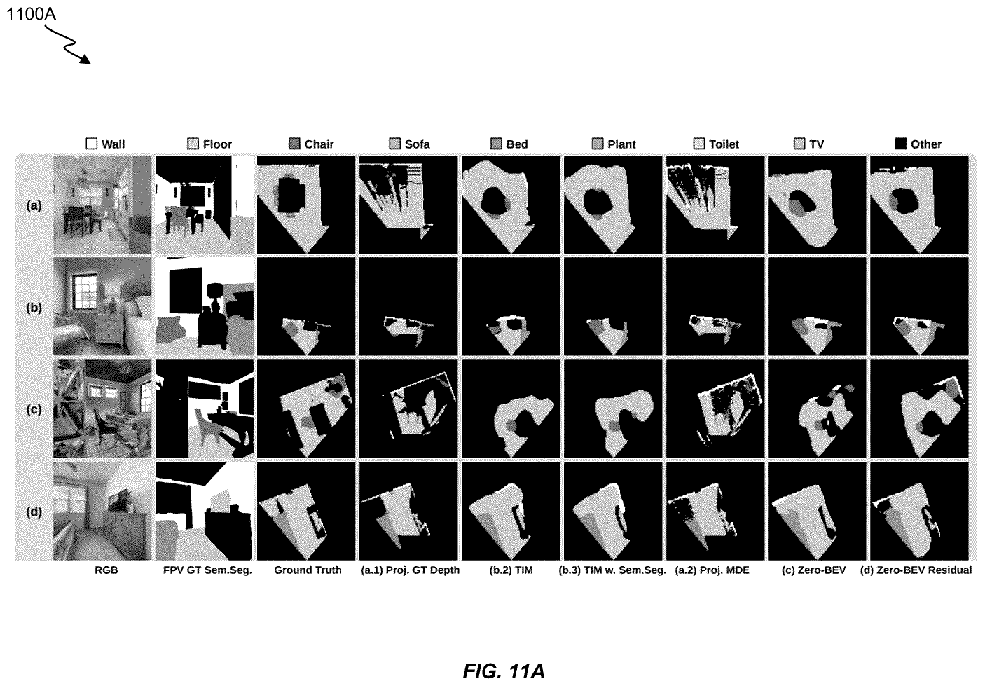

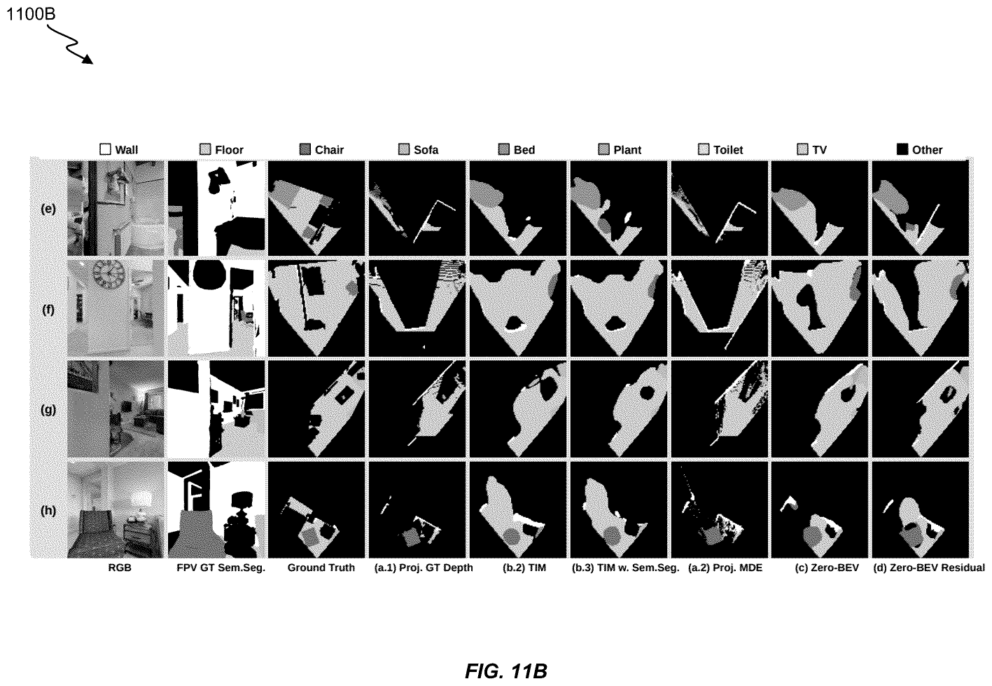

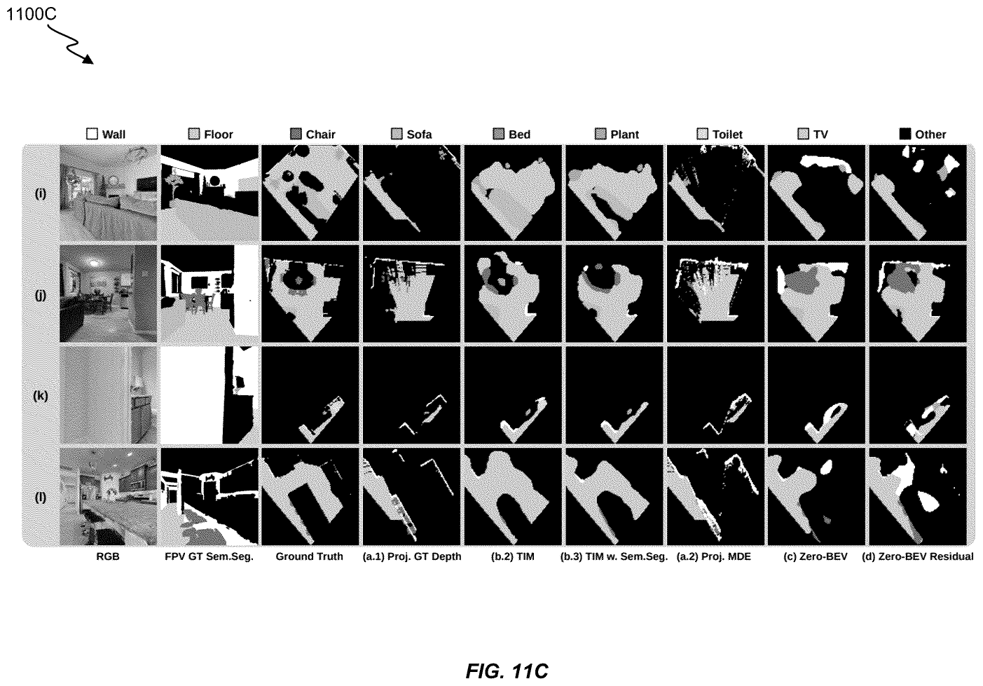

FIG. 11 shows additional qualitative results on the zero-shot BEV semantic segmentation task for zero-BEV variants and other baselines. In FIG. 11 (a.1) uses ground-truth depth and methods (c.2) and (c.3) are not zero-shot capable, thus not comparable. While the other methods such as (a.2), (c) and (d) are zero-shot models. In the projected BEV maps each category is assigned a different color (e.g., chair is red, bed is orange). FIG. 11A illustrates qualitative results on the HM3DSem dataset for a first set of test scenes, in accordance with an example implementation of the present disclosure.

FIG. 11B illustrates qualitative results on the HM3DSem dataset for a second set of test scenes, in accordance with an example implementation of the present disclosure. Images in FIG. 11A and FIG. 11B row (a) to (h) showcase strong performance of the disclosed approaches, with results that are clearly superior to the zero-shot alternative (a.2) of back-projecting semantic segmentation masks to the ground using estimated depth. Qualitatively, BEV maps appear very close, if not superior, to those obtained by TIM (b.2) and TIM (b.3), a fully-supervised, non zero-shot, state-of-the-art method.

FIG. 11C illustrates qualitative results on the HM3DSem dataset for a third set of test scenes, in accordance with an example implementation of the present disclosure. The last four rows of results FIG. 11C (i−1) shows where zero-BEV variants achieve relatively poor results. These seem to be cases where input images feature less common perspectives and significant occlusions. FIG. 11C row (j) is interesting because it includes an annotation error: the flowerpot on the dining table, on the top part of the BEV map, is wrongly labeled as chair. Standard TIM (b.2), without access to FPV semantic segmentation masks, correctly predicts a plant on the table, while TIM (b.3) and Zero-BEV variants (c) and (d), all using FPV semantic segmentation, struggle to predict reasonable predictions for this part of the scene.

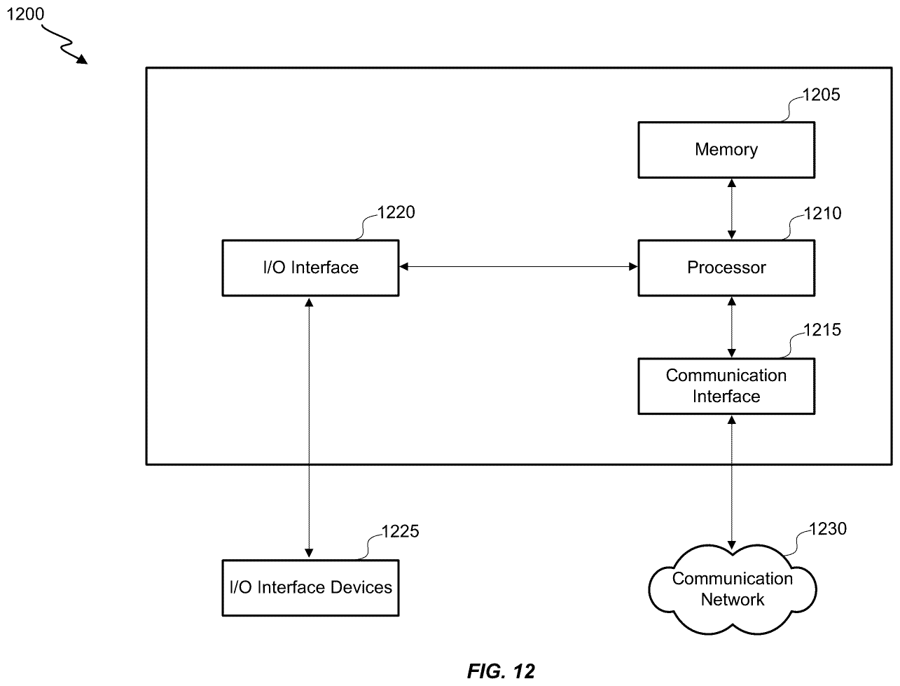

FIG. 12 is a block diagram of an example computing system 1200 that may be utilized to perform one or more aspects of the disclosure described herein. For example, in some implementations, computing system 1200 may be utilized to generate, train, and/or deploy the system 100 to project an FPV image to a BEV plane that may form part of an embedded system such as an autonomous system (e.g., autonomous or semi-autonomous cars, robots and drones) and a wearable system (e.g., head mounted displays, smart watches, etc). The computing system 1200 typically includes at least one processor 1210 that communicates with several peripheral devices via buses. These peripheral devices may further include, for example, a memory 1205 (e.g., RAM, a magnetic hard disk or an optical storage disk), I/O interface devices 1225 via I/O interface 1220 and a communication network 1230 via communication interface 1215.

Communication interface 1215 provides an interface to communication networks 1030 and is coupled to corresponding interface devices in other computing devices. The communication interface 1215 may include suitable logic, circuitry, and interfaces that may be configured to establish and enable communication between the processor 1210 and various other components of the system 1200 via the communication network 1230. The communication interface 1215 may be implemented by use of various known technologies to support wired and/or wireless communication of the processor 1210 with the communication network 1230. Examples of the communication interface 1215 may include, but are not limited to, an antenna, a radio frequency (RF) transceiver, digital subscriber line (“DSL”) card, cable modem, network interface card, wireless network card, or other interface device capable of wired, fiber optic, or wireless data communications, one or more amplifiers, a tuner, one or more oscillators, a digital signal processor, a coder-decoder (CODEC) chipset, a subscriber identity module (SIM) card, a local buffer circuit, and the like. Aspects of the present disclosure are intended to include or otherwise cover any type of the communication interface 1215 including known, related art, and/or later developed network interfaces, without deviating from the scope of the present disclosure.

The processing circuitry within processor(s) 1210 may include suitable logic, instructions, circuitry, interfaces, and/or codes for executing various data processing and computational operations performed by the data processing server for secure ticketing of authenticated users. The processing circuitry may be configured to host and enable a console running on (or installed on) a user device (not shown) to execute various operations associated with the system 100 by communicating one or more commands and/or instructions over the communication network 1230. Examples of the processing block 1210 may include, but are not limited to, an ASIC processor, a RISC processor, a CISC processor, a FPGA, and the like. Aspects of the present disclosure are intended to include or otherwise cover any type of the processors 1210 including known, related art, and/or later developed processing circuitries, without deviating from the scope of the present disclosure.

The input and output (I/O) interface 1220 may include suitable logic, circuitry, interfaces, and/or code that may be configured to receive inputs (such as the FPV image 105) and transmit one or more outputs generated by the processor 1210 (such as the BEV maps 110). The I/O interface 1220 may further include various input and output data ports (not shown) for different I/O devices 1225 such that a variety of I/O devices (with different and/or specific requirements and configurations) can be coupled to the processor 1210.

The I/O interface devices 1225 allow user interaction with computing system 1200.

Input interface devices may include, but are not limited to, a keyboard, pointing devices such as a mouse, a joystick, trackball, touchpad, or graphics tablet, a scanner, a touchscreen incorporated into the display, image capturing device such as sensing unit 115, audio input devices such as voice recognition systems, microphones, and/or other types of input devices. In general, use of the term “input device” is intended to include all possible types of devices and ways to input information into computing system 1200 or onto a communication network 1230. Output interface devices may include a display subsystem, a printer, a fax machine, or non-visual displays such as audio output devices, which may be used to output a BEV map generated by the system 100. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing system 1200 to the user or to another machine or computing device.

Storage systems (e.g., memory 1204) store programming and data constructs that provide the functionality of some, or all the modules described herein, including projection module 120 and training module 113 and training data (e.g., training data 114) of system 100. These software modules are generally executed by processor 1210 alone or in combination with other processors. Memory 1205 used in computing system 1200 can include several memories including a main random-access memory (RAM) for storage of instructions and data during program execution, a mass storage device that provides persistent storage for program and data files, and may include a hard disk drive, a floppy disk drive along with associated removable media, a CD-ROM drive, a read only memory (ROM) in which fixed instructions are stored, an optical drive, or removable media cartridges. The modules implementing the functionality of certain implementations may be stored in the mass storage system, or in other machines accessible by the processor(s) 1210 via I/O interface 1220.

Computing system 1200 can be of varying types including a workstation, server, computing cluster, blade server, server farm, or any other data processing system or computing device. Due to the ever-changing nature of computers and networks, the description of computing system 1200 depicted in FIG. 12 is intended only as a specific example for purposes of illustrating some implementations. Many other configurations of computing system 1200 are possible having more or fewer components than the computing device depicted in FIG. 12.

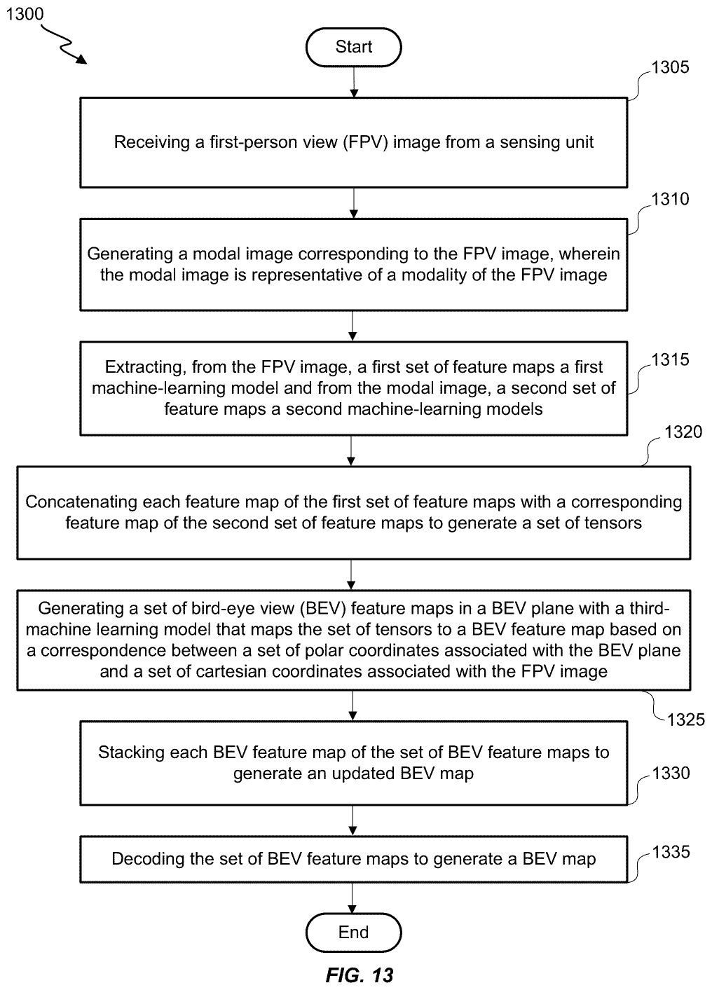

FIG. 13 is a flow chart that depicts a computer-implemented method for projecting a modality of the FPV image to the BEV map, according to an exemplary embodiment. The method includes receiving a first-person view (FPV) image from a sensing unit, at block 1305. Alternatively, the FPV image may be received from a storage device after being stored thereon by a sensing unit.

The corresponding modal image may be generated at block 1310, where the modal image is associated with any modality (e.g., bounding boxes, semantic segmentation) of the FPV image. The FPV image and the modal image may be fed to a feature extractor that may include a first one or more ML models for the FPV image and a second one or more ML models from the modal image. The feature extractor may extract a set of feature maps from each layer of a first ML model and a second set of features from each layer of a second machine-learning model, at block 1315. At a subsequent block 1320, each feature map of the first set of feature maps may be concatenated with a corresponding feature map of the second set of feature maps to generate a set of tensors. At block 1325, a set of bird-eye view (BEV) feature maps may be generated by deploying a transformer-based network that is configured to map each tensor of the set of tensors independently to a BEV feature map. This mapping is based on a correspondence between a set of polar coordinates associated with a BEV plane and a set of cartesian coordinates associated with the FPV image. The transformer-based network is configured to compute one or more attention metrics of the input set of tensors. In some embodiments, at block 1330 (which is optional), each BEV feature map of the set of BEV feature maps is stacked together to generate an updated BEV feature map. At block 1335, the set of BEV feature maps is decoded to generate a BEV map.

Moreover, though the description of the present disclosure has included description of one or more aspects, configurations, or aspects and certain variations and modifications, other variations, combinations, and modifications are within the scope of the present disclosure, e.g., as may be within the skill and knowledge of those in the art, after understanding the present disclosure. It is intended to obtain rights which include alternative aspects, configurations, or aspects to the extent permitted, including alternate, interchangeable and/or equivalent structures, functions, ranges, or steps to those claimed, whether or not such alternate, interchangeable and/or equivalent structures, functions, ranges or steps are disclosed herein, and without intending to publicly dedicate any patentable subject matter.

As one skilled in the art will appreciate, the systems (i.e., the systems 100, 200, or 1200) as disclosed hereinabove include a number of functional blocks in the form of a number of units and/or engines. The functionality of each unit and/or engine goes beyond merely finding one or more computer algorithms to carry out one or more procedures and/or methods in the form of a predefined sequential manner, rather each engine explores adding up and/or obtaining one or more objectives contributing to an overall functionality of the systems. Each unit and/or engine may not be limited to an algorithmic and/or coded form, rather may be implemented, by way of one or more hardware elements operating together to achieve one or more objectives contributing to the overall functionality of the systems and the user device 104 as presented hereinabove. Further, it will be readily apparent to those skilled in the art, all the steps, methods and/or procedures of the systems are generic and procedural in nature and are not specific and sequential.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The present description provides preferred exemplary embodiments only, and is not intended to limit the scope, applicability, or configuration of the disclosure. Rather, the present description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the present description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

What is claimed is:

1. A computer implemented method, comprising:
receiving a first-person view (FPV) image of a scene;
generating a modal image corresponding to the FPV image, wherein the modal image is representative of a feature of the FPV image;
extracting, from the FPV image, a first set of feature maps with a first machine-learning model, and from the modal image, a second set of feature maps with a second machine-learning model;
concatenating one or more of the first set of feature maps with corresponding one or more of the second set of feature maps to generate a set of tensors;
generating a set of bird-eye view (BEV) feature maps in a BEV plane with a third machine-learning model that maps the set of tensors to the set of BEV feature maps based on a correspondence between a set of polar coordinates associated with the BEV plane and a set of cartesian coordinates associated with the FPV image; and
decoding the set of BEV feature maps with a fourth machine-learning model to generate a BEV map with the feature projected thereon for output to an output device.

2. The method of claim 1, wherein the second machine-learning model is trained with a data that is not representative of the feature of modal image.

3. The method of claim 2, wherein the data is a set of data triplets (I^{rgb}, I^{zero}, M^{zero}), wherein each data triplet is generated by (i) generating a three-dimensional (3D) scene mesh structure; (ii) from an FPV position in a 3D scene mesh structure, recording an FPV image I^{rgb}, (iii) applying a synthetic texture to the 3D scene mesh structure, (iv) from the FPV position in the 3D scene mesh structure with the applied synthetic texture, recording an FPV modal image I^{zero}, (v) from a BEV position in the 3D scene mesh structure with the applied synthetic texture, recording a BEV feature map M^{zero}, wherein the FPV modal image I^{zero} and the BEV feature map M^{zero} represent the same scene, and wherein the synthetic texture is decorrelated from the scene.

4. The method of claim 1, wherein the receiving receives the FPV image of the scene from a sensing unit and the decoding outputs to the output device that is one of a display and a printer.

5. The method of claim 1, further comprising processing the BEV feature maps with a fifth machine-learning model for stacking the set of BEV feature maps before decoding the set of BEV feature maps with the fourth machine-learning model.

6. The method of claim 5, wherein the first, second, third, fourth and fifth machine-learning models are a first, second, third, fourth and fifth neural networks, respectively.

7. The method of claim 1, wherein the first, second, third and fourth machine-learning models are a first, second, third and fourth neural networks, respectively.

8. The method of claim 7, wherein the second neural network is trained using data with a synthetic image pattern superimposed on a 3D mesh of the scene.

9. The method of claim 8, wherein the synthetic image pattern is not correlated with the scene.

10. The method of claim 8, wherein the second neural network is trained using a training data of one or more modalities.

11. The method of claim 10, wherein the fourth neural network decodes one or more auxiliary outputs associated with the one or more modalities of the training data.

12. The method of claim 10, wherein the one or more auxiliary outputs decoded by the fourth neural network are one or more of navigability of the scene and obstacles in the scene.

13. The method of claim 7, wherein the third neural network is a transformer-based network configured to compute one or more attention metrics.

14. The method of claim 13, further comprising for each tensor of the set of tensors:
generating a contextualized feature column by a column encoder configured to compute a self-attention for each column of the tensor of the set of tensors; and
transforming the contextualized feature column to a BEV ray map by deploying a ray decoder configured to compute a sequence of one or more self-attentions and one or more cross-attentions for each ray map of the BEV feature map of the set of BEV feature maps.

15. The method of claim 1, further comprising generating a residual BEV feature map for the FPV image and the modal image; wherein the fourth machine-learning model process the residual BEV feature map and the BEV feature maps.

16. The method of claim 15, wherein generating the residual BEV feature map further comprising:
determining a monocular depth value of the FPV image using a monocular depth estimation technique;
generating a perspective projection of the FPV image using inverse perspective projection of the modal image and the monocular depth value of the FPV image;
pooling the perspective projection to generate a single-channel tensor of the FPV image; and
passing the single-channel tensor through the one or more embedding layers to generate the residual BEV feature map.

17. The method of claim 1, wherein the feature of the modal image is a modality of the FPV image that includes semantic segmentation, motion vector, optical flow, occupancy, mask, object instance, scene navigation, scene obstacles or object bounding box.

18. A system comprising:
one or more data processors; and
a non-transitory computer readable storage medium containing instructions which, when executed on the one or more data processors, cause the one or more data processors to perform actions including:
receiving a first-person view (FPV) image of a scene;
generating a modal image corresponding to the FPV image, wherein the modal image is representative of a feature of the FPV image;
extracting, from the FPV image, a first set of feature maps with a first machine-learning model, and from the modal image, a second set of feature maps with a second machine-learning model;
concatenating one or more of the first set of feature maps with corresponding one or more of the second set of feature maps to generate a set of tensors;
generating a set of bird-eye view (BEV) feature maps in a BEV plane with a third machine-learning model that maps the set of tensors to the set of BEV feature maps based on a correspondence between a set of polar coordinates associated with the BEV plane and a set of cartesian coordinates associated with the FPV image; and
decoding the set of BEV feature maps with a fourth machine-learning model to generate a BEV map with the feature projected thereon for output to an output device.

19. A computer-program product tangibly embodied in a non-transitory machine-readable storage medium, including instructions configured to cause one or more data processors to perform actions including:
receiving a first-person view (FPV) image of a scene;
generating a modal image corresponding to the FPV image, wherein the modal image is representative of a feature of the FPV image;
extracting, from the FPV image, a first set of feature maps with a first machine-learning model, and from the modal image, a second set of feature maps with a second machine-learning model;
concatenating one or more of the first set of feature maps with corresponding one or more of the second set of feature maps to generate a set of tensors;
generating a set of bird-eye view (BEV) feature maps in a BEV plane with a third machine-learning model that maps the set of tensors to the set of BEV feature maps based on a correspondence between a set of polar coordinates associated with the BEV plane and a set of cartesian coordinates associated with the FPV image; and
decoding the set of BEV feature maps with a fourth machine-learning model to generate a BEV map with the feature projected thereon for output to an output device.

20. The computer-program product of claim 19, wherein the second machine-learning model is trained with a data that is not representative of the feature of modal image.
